(19) United States
(12) Patent Application Publication
(10) Pub. No.: US 2025/0117737 A1
(43) Pub. Date: Apr. 10, 2025

(54) API FOR REMOTE MONITORING OF APPLICATION INTERACTION

(71) Applicant: DOORDASH, INC., San Francisco, CA (US)

(72) Inventors: George Siqiao WANG, San Mateo, CA (US); Martin ANET, Austin, TX (US); Jeff COSGRIFF, San Francisco, CA (US); Bryan Chunyen HUANG, San Francisco, CA (US)

(21) Appl. No.: 18/982,207

(22) Filed: Dec. 16, 2024

Related U.S. Application Data
(63) Continuation of application No. 17/159,249, filed on Jan. 27, 2021.
(60) Provisional application No. 63/083,364, filed on Sep. 25, 2020.

(51) Int. Cl. G06Q 10/0832; G06N 20/00; G06Q 10/083; G06Q 10/0834; G06Q 10/087; G06Q 30/0601; G06Q 50/40

(52) U.S. Cl. CPC G06Q 10/0832; G06N 20/00; G06Q 10/0834; G06Q 10/0838; G06Q 10/087; G06Q 30/0633; G06Q 30/0639; G06Q 50/40

(57) ABSTRACT

Examples include a computing device that receives, from an application on a mobile device, a first communication requiring the computing device to perform at least a first action. The computing device implements a first time period during which the computing device waits before performing the first action, and receives, in real time and via an API, one or more second communications indicative of user activity with respect to the application. Based on receiving an indication that the application has been closed on the mobile device for the threshold time, the computing device performs the first action before expiration of the first time period. Alternatively, based on receiving an indication that the user is actively interacting with a user interface of the application on the mobile device, the computing device performs, after the expiration of the first time period, at least one of the first action or a second action.

### CROSS-REFERENCES TO RELATED APPLICATIONS

This application is a continuation of, and claims priority to, U.S. patent application Ser. No. 17/159,249, filed Jan. 27, 2021, which claims the benefit of U.S. Provisional Patent Application No. 63/083,364 filed Sep. 25, 2020, all of which are incorporated by reference herein.

### BACKGROUND

People may sometimes prefer to have food or other items delivered to them. To meet this demand, an agent (e.g., delivery agent, agent, etc.) may deliver one or more items from a merchant to a specified delivery location. For example, a service may enable a user of the service to order items from any of a variety of merchants, and may arrange for agents to deliver the items from the merchants to the user within a relatively short period of time, such as within an hour or less in some cases. Further, the user may sometimes want to receive items from multiple merchants. However, this may be technologically challenging to accomplish efficiently, and typically requires that a separate order be placed with each different merchant, which results in multiple agents being used to deliver items from the different merchants to the same user.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system that enables bundling of orders according to some implementations.

FIG. 2 illustrates an example user interface that may be presented on a display of a user device according to some implementations.

FIG. 3 illustrates an example user interface that may be presented on the display of the user device according to some implementations.

FIG. 4 illustrates an example user interface that may be presented on the display of the user device according to some implementations.

FIG. 5 illustrates an example user interface that may be presented on the display of the user device according to some implementations.

FIG. 6 illustrates an example user interface that may be presented on the display of the user device according to some implementations.

FIG. 7 illustrates an example user interface that may be presented on the display of the user device according to some implementations.

FIG. 8 illustrates an example diagram for determining additional merchants that meet a location criterion for bundling items with an order of a first merchant according to some implementations.

FIG. 9 is a conceptual block diagram illustrating an example of determining merchants and items to present on a user device for enabling bundled orders according to some implementations.

FIG. 10 is a flow diagram illustrating an example process for rule-based bundling for logistical efficiency according to some implementations.

FIG. 11 is a flow diagram illustrating an example process for managing a communication delay based on detecting remote interaction on a user device according to some implementations.

FIG. 12 illustrates select components of the service computing device(s) that may be used to implement some functionality of the bundle order processing services described herein.

FIG. 13 illustrates select example components of an example merchant device according to some implementations.

FIG. 14 illustrates select example components of the user device that may implement the functionality described above according to some examples.

FIG. 15 illustrates select example components of the agent device that may implement the functionality described above according to some examples.

### DESCRIPTION

Some implementations herein are directed to techniques and arrangements for enabling a user of a service to remotely view and select items available to be added to (i.e., bundled with) a delivery order that the user has already placed or that the user intends to place. Examples of “bundling”, as used herein, may include an act of logically linking two or more separate orders together, with one order serving as an original or parent order (i.e., a first order) and the other order(s) being bundled orders that may be processed with the first order and typically delivered with the first order. For example, the bundled orders herein may be processed using various technologies to attempt to ensure that the same agent picks up and delivers the first order and the bundled order(s). For instance, bundling can increase logistical efficiency by having a single agent deliver multiple items from multiple different merchants to the same delivery location as part of the same delivery.

As one example, a user may use a user application executing on a user device to access a service to place a first order for a first item to be picked up by an agent from a first merchant at a first merchant location and delivered to the user at a specified delivery location. Following placement of the first order for the first item, a service computing device that provides the service may send the order to the first merchant to begin preparation of the order. In addition, the service computing device may determine one or more second merchants who are within a threshold distance of at least one of an agent location, the first merchant location, a route between an agent location and the first merchant location, or a route between the first merchant location and the delivery location.

The service computing device may select, based on applying a plurality of selection rules and, in some examples, machine learning, at least one of the second merchants to present in a user interface (UI) on the user device. For example, the selection rules may enable a large number of potential second merchants and items offered by the second merchants to be narrowed down to a smaller number subset able to be presented in a small form factor user interface, such as on a mobile device. The merchant(s) may be selected for the subset based on a variety of considerations, such as predicted preparation times of the items offered by the second merchants, predicted pickup times for the items offered by the second merchants, purchase history of the user, purchase histories of other users who purchased similar items from the first merchant or from merchants determined to be similar to the first merchant, prior agreements between the service and one or more of the second merchants, such as advertising or marketing agreements, travel time from the first merchant to the second merchant and/or from the second merchant to the delivery location, and so forth.

The service may send, to the user device, information about the selected second merchants to cause the user device to present a user interface including the selected second merchants. Further, the user interface on the user device may inform the user of a threshold time limit for selecting one or more additional items to bundle with the first order. For instance, the service may implement a threshold time limit (delay) before sending the first order to an agent for assigning the agent to pick up and deliver the first order. The threshold time limit may allow the user time to decide whether to order one or more additional items from the second merchant(s) to bundle with the first order.

In addition, by implementing the threshold time limit prior to assigning an agent, the logistical efficiency of the system can be improved by ensuring that the same agent can be used for picking up and delivering the first order as well as for picking up and delivering any additional items that the user may decide to bundle with the first order. For instance, if a particular agent is immediately assigned to pick up and deliver the first order, the particular agent may also be assigned to deliver other orders, or may pick up and deliver the first order before the user selects an additional item, and so forth, which may make it impractical or otherwise inefficient for the particular agent to also pick up and deliver any additional items bundled by the user with the first order. Such a situation may necessitate that a different agent be assigned to pick up and deliver the additional items, which is typically an inefficient and undesirable result.

Furthermore, the implemented delay may be terminated early or, alternatively, may be extended, based on detecting user interaction with the user application on the user device. For instance, the user application executing on the user device may monitor and communicate to the service computing device the user interactions with respect to the second merchant(s) and the second merchant's items, menus, etc., such as to enable the service computing device to determine remotely whether the user is browsing the items available from one of the second merchants, whether the user is not browsing the items, whether the user has closed the user application, whether the user has left the application idle while using other applications, and so forth. In some examples, an application programming interface (API) may be used for communicating the user interactions with the user application to the service computing device.

Based on the user interaction information, the service computing device may determine whether to end the delay early and proceed with assigning an agent; maintain the delay for a predetermined time; or extend the delay for an additional time to give the user additional time to select an item to bundle with the first order. For example, if the application detects that the user has closed the application, the service computing device may determine to end the delay early, and may proceed with requesting an agent to pick up and deliver the first order. Further, if the service computing device detects that the user still has the application open, but is not actively browsing the items, the delay may be maintained for the predetermined time or other specified time. In addition, if the communications received by the service computing device from the user application indicate that the user is actively browsing the items available from the second merchant, the service computing device may determine to extend the delay. In some cases, prior to extending the delay, the service may send a message to cause the user application to present a notification in the user interface to determine whether the user would like additional time to select an item from the second merchant for creating a bundled order, and may extend the delay based at least in part on the user's response.

In some examples herein, by combining one or more items from the one or more second merchants with the first order from the first merchant, rather than creating a separate second order, the additional second item(s) may be delivered to the user with the first item, and the user may be able to avoid payment of additional delivery fees, may pay reduced delivery fees, a combined tip, or the like. Further, the system herein may improve the overall efficiency of the service, reduce fuel consumption, and provide additional users for additional merchants.

Further, in some examples, rather than creating the bundled order after placement of the first order, the user may instead be presented with an option of creating a bundled order upon opening the application, such as based on a suggestion presented in the user interface on the user device. Alternatively, the user may be presented with a suggestion for creating a bundled order upon selection of a first merchant for browsing items offered by the first merchant. In some examples, the service computing device may determine merchants to offer as a bundle, while in other examples, the service may determine possible second merchants based on receiving an indication in interest in a first merchant from the user device, or upon receiving an indication of interest in ordering a particular item from the first merchant.

For discussion purposes, some example implementations are described in the environment of enabling users to place orders with merchants for delivery, such as to enable a user to add one or more items from a second merchant to an order from a first merchant. However, implementations herein are not limited to the particular examples provided, and may be extended to other service environments, other system architectures, other types of goods, and so forth, as will be apparent to those of skill in the art in light of the disclosure herein.

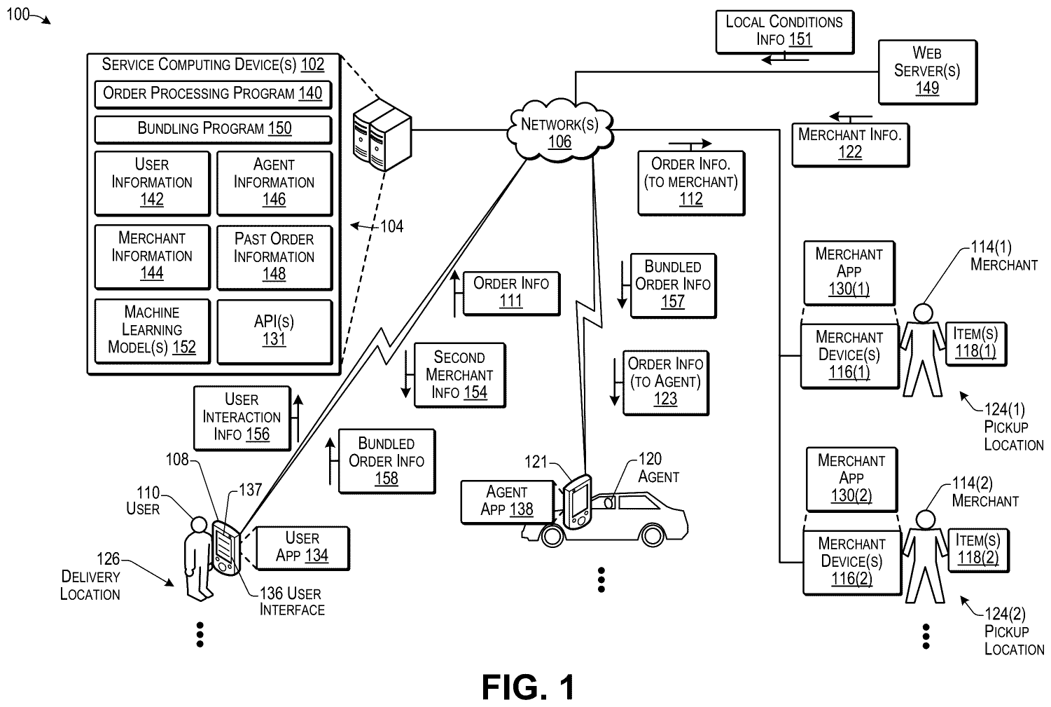

FIG. 1 illustrates an example system 100 that enables bundling of orders according to some implementations. The system 100 includes one or more service computing devices 102 of a service provider 104 that may communicate, over one or more networks 106, with a user device 108 of a user 110, such as for receiving order information 111 from the user device. The order information 111 may include information about an order placed by the user 110 using the user device 108. In some examples, there may be a large number of users 110 and associated user devices 108 that use a service provided by the service computing device(s) 102. For clarity of illustration, only one user device 108 and user 110 are illustrated in example of FIG. 1, with the understanding that numerous users 110 and user devices 108 may be participating in the system 100.

Based on receiving the order information 111, the service computing device(s) 102 may send, over the one or more networks 106, order information 112 to a merchant device 116 associated with a particular merchant 114 of a plurality of merchants 114, which in this example includes a first merchant 114(1) and a second merchant 114(2), and corresponding first merchant device 116(1) and second merchant device 116(2), respectively. For instance, there may be a large number of merchants 114 that use the service provided by the service computing device(s) 102. For clarity of illustration, only the first and second merchants, 114(1) and 114(2), and corresponding first and second merchant devices, 116(1) and 116(2), respectively, are illustrated in FIG. 1, with the understanding that numerous merchants 114 and merchant devices 116 may be participating in the system 100. The order information 112 sent to the merchant 114 may identify one or more items 118 ordered by the user 110 from the particular merchant 114. For instance, each merchant 114(1), 114(2), may offer one or more items 118(1), 118(2), respectively, which may be ordered by the user 110 for delivery.

In some cases, the order information 112 may also specify a time at which an item 118 is to be picked up by an agent 120. For example, there may be a plurality of agents 120 and associated agent devices 121 that participate in the service provided by the service computing device(s) 102. The service computing device(s) 102 may communicate with the agent device(s) 121 over the one or more networks 106. For clarity of illustration, only one of the agents 120 is illustrated in FIG. 1, with the understanding that numerous agents 120 and associated agent devices 121 may be participating in the system 100.

As one example, suppose that the user has ordered a first item 118(1) from the first merchant 114(1). The first merchant device 116(1) may receive the order information 112 from the service computing device(s) 102 which may include a request for the first merchant 114(1) to prepare the first item 118(1) for pickup. In response, the first merchant device 116(1) may send a response with merchant information 122. In some examples, the response sent by the first merchant device 116(1) may be an automatic reply, while in other cases, the response may be generated at least in part by the merchant 114(1). For instance, the service computing device(s) 102 may predict the preparation time for the first order and/or may specify a pickup time for the first order. In this case, the merchant information 122 sent by the merchant device 116(1) to the service computing device(s) 102 may indicate that the predicted preparation time is correct and/or may confirm the pickup time specified by the service computing device(s) 102. In other examples, the order information 112 sent to the merchant device 116(1) may include an inquiry as to when the order will be prepared and ready for pick up, and the merchant device 116(1) may include, with the merchant information 122, a predicted preparation time and/or a specified time at which the first order will be ready for pickup.

In either event, in response to receiving the merchant information 122 from the first merchant device 116(1), the service computing device(s) 102 may send order information 123 to a particular agent device 121 of a particular agent 120, i.e., the agent device 121 of the agent 120 in this example, who will pick up the first item 118(1) from the first merchant 114(1) and deliver the item 118(1) to the user 110 who placed the order. For instance, each merchant 114(1), 114(2), . . . , may be associated with a respective pickup location 124(1), 124(2), . . . , which may typically be the respective merchant's place of business. Furthermore, each user 110 may be associated with a respective delivery location 126 to which an order is requested to be delivered.

Further, as discussed additionally below, in some examples, the service computing device(s) 102 may delay assigning the first order to the agent 120 for a period of time to allow the user 110 to select one or more items from another merchant to bundle with first item 118(1). For instance, the delay may be implemented to help ensure that the agent 120 assigned to deliver the first order will also be able to deliver the bundled order, if any. This can significantly improve the efficiency of the system 100 for providing bundled orders.

The order information 123 sent to the agent 120 may include information about the pickup location 124(1) for the first order, the pickup time, and the delivery location 126 for the first order. Additionally, in some cases, the order information 123 may include an amount that the agent 120 will be paid if the agent 120 accepts the delivery job, and/or other information related to the order, such as pickup details and/or delivery details.

In the illustrated example, each merchant device 116(1), 116(2), . . . , may be a computing device, such as a desktop, laptop, tablet, smart phone, or the like, and may include a respective instance of a merchant application 130(1), 130(2), . . . , that executes on the respective merchant device 116(1), 116(2), . . . . For example, the merchant application 130 may be configured to communicate with the service computing device(s) 102, such as for receiving the order information 112 and for sending the merchant information 122. In some examples, the merchant application 130 and the service computing device(s) 102 may communicate with each other via one or more application programming interfaces (APIs) 131.

Further, the merchant device 116 may include one or more output devices, such as speakers (not shown in FIG. 1), that the merchant application 130 may use to audibly notify the respective merchant 114 that an order has been received. Additionally, or alternatively, the merchant device 116 may include a display (not shown in FIG. 1) that the merchant application 130 may use for presenting the order information 112 to the merchant 114. For instance, the merchant application 130 may present the order information 112 on the merchant device 116 in one or more user interfaces.

In some examples, the merchant application 130 may keep track of orders received by the respective merchant 114. For example, the merchant 114 may receive orders for items 118 from the service computing device(s) 102. The merchant 114 also may receive orders for items 118 from users who walk into the merchant's place of business and/or who otherwise place orders to eat in or carry out. Thus, the merchant information 122 sent to the service computing device(s) 102 may indicate a current workload for each merchant 114 based on the number of orders received by the merchant 114 over any given time. The service computing device(s) 102 may use this merchant workload information in some examples when calculating preparation times for ordered items and/or additional items.

In addition, in some cases, the merchant information 122 may include inventory information for the respective merchant 114. For instance, if a particular merchant 114 is out of a particular item 118, the item information, such as a list of available merchant items, sent to and presented on the user devices 108 for a particular merchant 114 may exclude any items that are not currently in the inventory of the particular merchant and/or may indicate that these items are not currently available for ordering.

In addition, each user 110 may be associated with a respective user device 108 that may execute a respective instance of a user application 134. For example, the user 110 may use the user device 108, such as smart phones, tablet computers, wearable computing devices, laptops, desktops, or the like, and the user device 108 may have installed thereon the user application 134 for enabling interaction with the service computing device(s) 102. The user application 134 may present a user interface (UI) 136 on the user device 108 to enable the user 110 to browse and select one or more of the items 118 to purchase from one or more of the merchants 114 to be delivered to the user 110 by one or more of the agents 120. For example, the user application 134 may present merchant and item information in the user interface 136 on a display 137 associated with the user device 108 for enabling the user 110 to select one or more of the items 118 for an order.

In some cases, the delivery location of the user 110 may be determined by a GPS (Global Positioning System) receiver (not shown in FIG. 1) or other location sensor onboard the user device 108. The location information determined from the location sensor may be transmitted to the service computing device(s) 102 as the indicated delivery location 126. For example, Global Positioning Satellite (GPS) receivers and other Global Navigation Satellite System (GNSS) receivers (hereinafter collectively referred to by the common name “GPS receivers”) may be included in the user device 108. The term “GPS” as used herein may include any GNSS such as the GPS system, the Russian Global Navigation Satellite System (GLONASS), the Chinese BeiDou Navigation Satellite System (BDS), the European Union's Galileo system, the Japanese Quasi-Zenith Satellite System (QZSS), the Indian Regional Navigation Satellite System (IRNSS), any other satellite-based location positioning system, or any similar such system for providing accurate indications of a current location to a computing device such as the user device 108.

The system 100 provides a novel technological arrangement that enables users to order bundled items from multiple merchants based at least in part on a delivery location of the user and respective pickup locations of the respective merchants, as discussed additionally below. Further, the user application 134 may enable the user 110 to place an order, including a bundled order, in advance, such as for scheduling the order for delivery at a later time on the same day, at a specified time on a future day, or the like. For instance, the user 110 may be able to place an order through the user application 134 to have a lunch including bundled items from different merchants delivered at a specified delivery location at a specified time on a specified day. As mentioned above, in some cases, the bundling may be performed in advance when initially creating the order. Alternatively, the bundling may be performed when preparation of a first order is ready to begin. As one example, when the first merchant 114(1) begins preparation of the first item 118(1) for the order at the later point in time, the service computing device(s) 102 may send a communication to the user device, such as through an in-application notification, text message, or other electronic communication, to inquire as to whether the user would like to order one or more additional items from one or more other merchant to bundle with the order being prepared.

The user application 134 may further enable the user 110 to make a payment for an item and any additional items using the user application 134. For instance, the service provider 104 may charge a user account associated with the user 110 for an amount associated with a particular order. In some examples, the user application 134 and the service computing device(s) 102 may communicate with each other via one or more APIs 131. Additionally, or alternatively, the user application 134 may be a web browser, or the like, and the user 110 may navigate to a website associated with the service provider 104, and may use the website associated with the service provider 104 to place an order. Thus, in this case, the website may provide at least some of the functionality attributed to the user application 134 herein.

As mentioned above, the agents 120 are associated with respective agent devices 121 that execute respective instances of an agent application 138. For example, agents 120 may use agent devices 121, such as smart phones, tablet computers, wearable computing devices, laptops, or the like, and these agent devices 121 may have installed thereon the agent application 138. The agent application 138 may be configured to receive the order information 123 from the service computing device(s) 102 to provide the particular agent 120 with information for picking up a particular order from a merchant's pickup location 124 and for delivering the order to a user delivery location 126. The agent application 138 may further enable the agent 120 to respond to the service computing device(s) 102 to confirm acceptance of a delivery job.

Additionally, the agent application 138 may provide the service computing device(s) 102 with an indication of a current location of a particular agent device 121. For instance, one or more location sensors, such as GPS receivers, may be associated with each agent device 121. The agent is an active agent 120 (e.g., the agent has notified the service computing device(s) 102 that the agent 120 would like to have a delivery job assigned), the agent device 121 may determine location information from the GPS receiver and, based on this GPS information, the agent application 138 may send location information to the service computing device(s) 102, such as by providing an indication of a geographic location of each agent device 121 of each active agent. Thus, a subset of agent devices 121 associated with active agents may communicate with the service computing device(s) 102, and may send location information obtained from one or more location sensors associated with each agent device 121.

In some cases, another subset of agent devices 121 associated with the inactive agents may be periodically pinged by the service computing device(s) 102 to determine interest in becoming active and, if so, requesting current location information of the associated inactive agent device 121. Agents 120 who are interested in being activated may allow their agent devices 121 to respond with their location information, while those who are not interested in being activated may keep their location information private by not responding. In some examples, the agent application 138 and the service computing device(s) 102 may communicate with each other via one or more APIs 131. Alternatively, in other examples, the agent device 121 may receive the order information 123 via an SMS text message, or other electronic communication.

The one or more networks 106 can include any appropriate network, including a wide area network, such as the Internet; a local area network, such an intranet; a wireless network, such as a cellular network, a local wireless network, such as Wi-Fi and/or short-range wireless communications, such as BLUETOOTH®; a wired network, including fiber optics and Ethernet; or any other such network, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing device(s) 102, the user devices 108, the merchant devices 116, and/or the agent devices 121 are able to communicate over the one or more networks 106 using wired or wireless connections, and combinations thereof.

In the illustrated example, the service computing device(s) 102 may include an order processing program 140 that may be executed on the service computing device(s) 102 to provide, at least in part, the order processing functionality attributed to the service computing device(s) 102. The order processing program 140 may receive the order information 111 from the user 110 and may associate the order information 111 with user information 142 and merchant information 144. For instance, based on user identifying information that may be included with the order information 111, the order processing program 140 may associate the particular order information 111 with a particular user account. The order processing program 140 may access a user account included in the user information 142 to charge a particular user account for a particular order. In some examples, the user information 142 may include a separate user account for each user 110 that signs up to use the user application 134 for accessing the service offered by the service computing device(s) 102.

Furthermore, based on a particular merchant 114 identified by the order information 111, the order processing program 140 may associate the order information 111 with a merchant account of a particular merchant 114. The order processing program 140 may access the merchant account, which may be identified in the merchant information 144, to determine contact information for sending the order information 112 to the correct merchant device 116 so that the particular merchant 114 can receive the order and provide confirmation of the order. The order processing program 140 may further access the merchant account of the particular merchant 114 to credit payment to the particular merchant 114 that prepares the order. The merchant information 144 may include a separate merchant account for each merchant 114 that registers to use the merchant application 130 for accessing the service provided by the service computing device(s) 102.

In addition, the order processing program 140 may access agent information 146 to determine agent contact information for sending the order information 123 to a particular agent 120 of a plurality of agents to determine whether the particular agent 120 is willing to accept the delivery job of delivering the order to the user. The particular agent 120 may use the agent application 138 on the agent device 121 to receive a message with information about the order, and to respond with acceptance of the delivery job if the job is accepted. The particular agent 120 may subsequently pick up the order from the pickup location 124 of the particular merchant 114 (or pickup locations of multiple merchants in the case of a bundled order) and deliver the order to the particular user 110 at a specified delivery location 126. When the agent 120 has completed delivery of the order to the delivery location 126, the agent 120 may use the agent application 138 to inform the order processing program 140 that the delivery has been completed. The order processing program 140 may access an agent account included in agent information 146 for the particular agent 120 to credit the agent account of the particular agent 120 with payment for the delivery job. For example, the agent information 146 may include a separate agent account for each agent 120.

The order processing program 140 may store information associated with each order as past order information 148. For instance, the past order information 148 may include a day of the week, date, and time of day at which each order is received from a respective user 110. The past order information 148 may further include, for each order: merchant identifying information; user identifying information; items ordered; the pickup location 124; the delivery location 126; preparation time and pickup time for the order; location of the agent when the agent accepted the job for delivery of the order; predicted spoilage time for one or more ordered items; time that the order was picked up by the agent; time that the order was delivered to the user; amount paid for the order; feedback including records of any complaints or indications of spoilage; as well as other information, as discussed additionally below.

The service computing device(s) 102 may further include a bundling program 150 that may be executed by the service computing device(s) 102 to determine one or more additional merchants to display in the user interface 136 on the user device 108 for enabling the user 110 to create a bundled order if the user 110 so desires. For example, as discussed additionally below, the service computing device(s) 102 may apply a plurality of rules for selecting one or more second merchants about which to display information in the user interface 136 on the user device 108, such as following receipt of the order information 111, from the user device 108, for a first order of a first item 118(1) from the first merchant 114(1).

In addition, the user device 108 may often be a mobile device, such as a cell phone, smartphone, wearable device, or the like, that, due to screen size, has a small form factor user interface as the user interface 136. Consequently, it may be undesirable to display a large number of potential second merchants in the user interface 136 because crowding of too many second merchants onto the user interface 136 may make it difficult for the consumer to view and select a particular second merchant. To avoid this problem, the bundling program 150 may apply a plurality of rules and, in some cases, machine learning, to select one or more second merchants and associated menus to present in the user interface 136 based on intelligent selection of merchants and/or particular items that are determined to be likely to result in an order for one or more additional items being placed by the user 110 as part of a bundled order that is bundled with the first order.

In some examples, the selected second merchants may be displayed in the user interface 136, such as by displaying logos, pins, icons, or other indicators on a map that indicates a location of the second merchant(s) relative to the pickup location 124 of the first merchant and/or relative to the delivery location 126 of the user 110. The user 110 may tap on or otherwise select one of the indicators of one of the second merchants to view a menu of items available from the selected second merchant. Additionally, in some cases, the menu may have been optimized for presenting items likely to be selected by the user 110.

The second merchants may be selected for being displayed in the user interface 136 based on a plurality of different considerations, such as location of the second merchant pickup location, an estimated preparation time and pickup time for the first item that has been selected for the first order, an estimated preparation time and pickup time for each of the potential additional items, and so forth. For instance, the service computing device 102 may apply the plurality of rules, which may include applying machine learning in some cases, for determining a set of one or more second merchants, such as merchants having items that are compatible with the first order, for selecting additional items for creating a bundled order.

In some cases, when determining potential second merchants 114(2) to select for presentation to the user 110 for creating a bundled order, the bundling program 150 may determine a travel route that may be traveled by the agent 120 from the first merchant pick up location 124(1) to the user's delivery location 126, such as a travel route corresponding to a shortest agent travel time. In addition, the bundling program 150 may determine one or more second merchants 114 located within a threshold distance of the first merchant pickup location 124(1), within a threshold distance of the delivery location 126, and/or within a threshold distance of the travel route. Accordingly, the bundling program 150 may determine items available from these second merchants while taking into consideration the preparation time of the first item 118(1) plus the travel time of the agent 120 from the first merchant pickup location 124(1) to or from the pickup locations of the respective second merchants. For instance, in some examples, the agent 120 may be at a location where it is more efficient to pick up the second item 118(2) from the second merchant pickup location 124(2) before picking up the first item 118(1) from the first merchant pickup location 124(1).

When determining predicted agent travel times, the bundling program 150 may take into consideration actual travel times determined from the past order information 148 and various other considerations, such as current traffic, weather, local events, day of the week, etc. As one example, the bundling program 150 may access one or more web servers 149 or other databases over the one or more networks 106, or other sources of information, to obtain local conditions information 151, such as traffic, weather, local events, road closures, construction, and the like, for a current or future day. As another example, current traffic conditions may be determined based in part on information received from the agent devices 121, such as by tracking movement of the agent devices 121 within the service region over time through location information received from the GPS receiver onboard each agent device 121, or the like. For instance, the agent device 121 may be programmed by the agent application 138 to periodically report a current location to the service computing device(s) 102.

The one or more second merchants 114(2) to present to the user 110 may further be selected based on determining whether a second merchant 114(2) offers items that are likely to be compatible with the first order. Examples of items 118(2) that may be determined to be likely to be compatible may include items that may be considered to complement the item 118(1) in the first order. For instance, if the first order is for an entrée, the compatible items may include side dishes that are pairable with the selected entrée, and/or drinks, desserts, and so forth. Thus, compatible items may include items that data analysis and/or machine learning may indicate to be a natural combination or otherwise commonly bundled combination of goods. As another example, compatible items may include items with short or zero preparation time and short pickup time, particularly if the first order has a short time window following preparation before spoilage sets in.

In some cases, applying the rules for selection of the subset of second merchants to display in the user interface 136 may include execution of one or more machine-learning models 152 that may receive, as input, information about the user 110 (e.g., characteristics), the user's order (e.g., the first item 118(1) in the example discussed above), the first merchant 114(1), combinations thereof, of the like. Suitable machine-learning models 152 may include predictive models, decision trees, classifiers, regression models, such as linear regression models, support vector machines, stochastic models, such as Markov models and hidden Markov models, and artificial neural networks, such as self-organizing neural networks, recurrent neural networks, convolutional neural networks, modular neural networks, deep-learning neural networks, and so forth. For example, the machine-learning model 152 may be trained and tested using previously received transaction information for a large number of past orders from the past order information 148, such as based on past transactions and order histories for various different users, items, and merchants, as well as based on various other factors, such as time of day, time of year, geographic location, and so forth. The machine learning model 152 may output one or more items likely to be selected and/or one or more merchants most likely to have items likely be selected and that have a pickup location within a threshold distance of at least one of: the first merchant pickup location 124(1), the delivery location 126, or a route between the pickup location 124(1) and the delivery location 126.

In some examples, the menu of items presented for a selected second merchant may be optimized based at least in part on the first item 118(1) (e.g., type of item and other characteristics of the item) selected for the first order and various other considerations, such as characteristics of the user 110, past orders of the user 110, past orders of users similar to the user 110, and so forth, as discussed additionally below. For example, if the user selects a drugstore or convenience store as the second merchant, then, rather than presenting all of the thousands of items available from these merchants, the presented menu may have been optimized in advance for various scenarios and/or may be optimized in real time, such as based on information about the user 110. For instance, if the user 110 ordered a burger as the first item 118(1), the bundling program 150 may initially present items from the selected second merchant that are likely to be selected with a burger, such as drinks, snacks, or desserts, rather than other items that are less likely to complement a burger. In some examples, the past order information 148 may be used to determine the items or item types most likely to be selected in various different scenarios. Additionally, or alternatively, the machine learning model 152 may be trained to make this determination. Alternatively, if the selected first item 118(1) is a fruit smoothie, the menu of the second merchant may be optimized differently, such as for deemphasizing drinks, and instead presenting various other types of items, such as food items. In addition, the presented menu of the selected second merchant 114(2) may be optimized based on the past orders of the particular user 110, and/or based on past orders of users determined to be similar to the particular user 110, and/or based on analysis of a large number of past orders for the same or similar items, and so forth.

In the example discussed above, suppose that the user 110 uses the user application 134 to select the first item 118(1) as the first order for delivery from the first merchant 114(1). The user 110 may confirm the first order to cause the user application 134 to send the order information 111 for the first order to the service computing device(s) 102. In some examples, based on the item 118(1) included in the order information 111, the relative locations of the delivery location 126, the pickup location 124(1), and various other considerations, as discussed elsewhere herein, the service computing device(s) 102 may execute the bunding program 150 to determine one or more other merchants 114(2), . . . , who offer items that are complementary to the selected first item 118(1) or otherwise likely to be selected by the user 110 for bundling with the first item 118(1) included in the first order. For instance, the order for the first item 118(1) may be received by the service computing device(s) 102 executing the order processing program 140. The order processing program 140 may provide information about the first order to the bundling program 150. In addition, the order processing program 140 may send the first order information as order information 112 to the corresponding first merchant device 116(1) of the first merchant 114(1) who will provide the first item 118(1).

In some examples, the bundling program 150 may select one or more additional merchants as discussed above, such as the second merchant 114(2), and may send second merchant information 154 to the user device 108. The second merchant information 154 may further include or may otherwise initiate a time limit for the user 110 to select one or more second items for bundling. For example, to avoid an undesirably long wait for delivery of the first order and/or to avoid the possibility of spoilage of the first item 118(1), the user 110 may be presented with a threshold time limit for the user 110 to select one or more additional items to bundle with the first order. In some examples, a default time may be employed, such as 5 minutes, 10 minutes, etc., while in other examples, the threshold time limit may be based in part on a predicted preparation time and/or spoilage time for the first item.

As mentioned above, the threshold time limit may allow the user time to decide whether to order one or more additional items from the second merchant 114(2) to bundle with the first order. Furthermore, based on the threshold time limit, the service computing device(s) 102 may implement a delay in assigning an agent 120 for delivery of the first order. In particular, the logistical efficiency of the system can be improved by ensuring that the same agent is used for picking up and delivering the first order as well as for picking up and delivering any additional items that the user 110 may decide to bundle with the first order. The delay can help avoid a situation in which the first agent is assigned to pick up and deliver the first order, and a different agent is assigned to pick up and deliver any additional items selected by the user for bundling with the first order. As mentioned above, such a result would be inefficient and undesirable, and would negate the advantages of bundling orders in the first place.

In some cases, delay in assigning the delivery job to an agent may correspond to and/or may be based in part on the threshold time limit provided to the user. Further, the delay may be terminated early or, alternatively, may be extended, based on detecting user interaction with the user application 134 on the user device 108. For instance, the user application 134 executing on the user device 108 may monitor and communicate to the service computing device(s) 102 the user interactions with respect to the second merchant information 154 and the second items 118(2) offered by the second merchant 118(2). Thus, user application 134 on the user device 108 may be configured to send user interaction information 156 to the service computing device(s) 102, such as to enable the service computing device(s) 102 to determine remotely whether the user 110 is browsing the items 118(2) available from the second merchant 114(2), whether the user 110 is not browsing the items 118(2), whether the user 110 has closed the user application 134, whether the user 110 has left the user application 134 idle while using other applications, and so forth. In some examples, the one or more APIs 131 may include an API that is configured to be used for communicating, in real time, to the service computing device(s) 102, the user interactions with the second merchant information 154 presented by the user application 134 on the user device 108.

Based on the user interaction information, the service computing device(s) 102 may determine whether to end the delay early and proceed with assigning an agent to deliver the first order; maintain the delay for a predetermined time; or extend the delay for an additional time to give the user 110 additional time to select one of the items 118(2) to bundle with the first order. For example, if the user application 134 detects that the user 110 has closed the application, the service computing device(s) 102 may determine to end the delay early, and may proceed with sending a request to the agent 120 to pick up and deliver the first order. Further, if the service computing device(s) 102 detects that the user 110 still has the application open, but is not actively browsing the items, the delay may be maintained for the predetermined time or other specified time (e.g., at least as long as the threshold time limit provided to user 110 for selecting items for bundling). In addition, if the communications received by the service computing device(s) 102 from the user application 134 indicate that the user 110 is still actively browsing the second items 118(2) available from the second merchant 114(2), even though the threshold time limit has expired or will soon expire, the service computing device(s) 102 may determine to extend the threshold time limit and also extend the delay accordingly. In some cases, prior to extending the threshold time limit, the service computing device(s) 102 may send a message to the user device 108 to cause the user application 134 to present the message in the user interface 136 to determine whether the user 110 would like additional time to select an item 118(2) from the second merchant 114(2) for creating a bundled order, and may extend the delay based at least in part on the user's response.

If the user 110 selects a second item 118(2) from the second merchant 114(2) to bundle with the first item 118(1) from the first order, bundled order information 158 may be sent by the user application 134 to the service computing device(s) 102. For example, the bundled order information 158 may identify the second item 118(2) and the second merchant 114(2). In addition, the bundled order information may specifically indicate that the order for the second item 118(2) is bundled with the first order for the first item 118(1) to ensure that any incentive that may be offered for making the bundled order is provided to the user 110. For instance, the user 110 may be offered an incentive to create a bundled order, such as reduced delivery fees, unified tip, and the like.

The bundled order information 158 may be received by the service computing device(s) 102, and the service computing device(s) 102 may send order information 112 to the second merchant 114(2) for the bundled order information 158. In addition, if the time limit threshold has not yet expired, the user application 134 may continue to monitor and communicate the user interaction with the user application 134. For example, the user may still have the opportunity to add another bundled item to the bundled order. Thus, in some examples, while the user 110 is still browsing the items 118(2) offered by the second merchant 114(2), or browsing items offered by a third merchant (not shown in FIG. 1), it may be premature to end the delay and proceed with assign the bundled order to an agent. On the other hand, if the user interaction indicate the user is not likely to add another item to the bundled order (e.g., the user has closed the user application, etc.), the service computing device(s) 102 may determine to end the delay and proceed with sending a request with order information 123 to the agent 120.

In some implementations, rather than having a default threshold time limit for the user 110 to select items for bundling, the bundling program 150 may determine a predicted preparation time for the first item 118(1) such as based on the past order information 148 and/or based on the merchant information 122 received from the merchant device 116. For instance, the bundling program 150 may determine the predicted preparation time for the first item 118(1) from past order information 148 that indicates how long the first merchant 114(1) has taken to prepare the same or similar items in the past. In some examples, the merchant information 122 may include an indication of a current load on the merchant 114(1) (e.g., a number of orders received and still to be prepared), and this may be used when determining the predicted preparation time by determining past preparation times under similar loads. Additionally, or alternatively, the merchant information 122 provided to the service computing device(s) 102 from the merchant device 116 may include a predicted preparation time for the first item, as determined by the merchant.

Further, the bundling program 150 may determine predicted preparation times for items that may be offered as additional items available from the second merchant 114(2). In some examples, items offered by the second merchant 114(2) having preparation times less than the predicted preparation time of the first item 118(1) may be available initially as additional items available for bundling. As time elapses following sending of the order information 112 to the first merchant device 116(1), items having predicted preparation times longer than the remaining preparation time for the first item may be no longer available for bundling.

In some examples, the bundling program 150 may employ, at least in part, the past order information 148 to determine predicted item preparation times for ordered items and/or items offered as additional items. Thus, the bundling program 150 may determine, for a plurality of different times of day for a plurality of different days, and for a plurality of orders received for items provided by individual merchants over a past period of time, e.g., a past month, past two months, past year, etc., the actual preparation times for particular items offered by each merchant 114(1), 114(2), . . . . In addition, comparing merchant load information with the past order information 148, such as past preparation times for particular items when the merchant load was similar, may be used to provide an indication of the predicted preparation times for the first item 118(1) and each of the additional items 118(2). Additionally, if a particular merchant has run out of a particular item, this may be indicated by merchant inventory information received from the particular merchant by the service provider. Accordingly, the service provider may not include that particular item in the item information sent to the user device regarding the available additional items, or may otherwise indicate the particular item to be unavailable.

Based on applying the plurality of selection rules to determine one or more second merchants, and items from the one or more second merchants, to present to the user in the user interface 136 on the user device 108, the bundling program 150 may send the second merchant information 154 to the user device 108 of the user 110 who placed the first order. As one example, the bundling program 150 may send an initial push notification, such as an in-application notification, an email, a text message, or other electronic communication, about available merchants and/or additional items with an order confirmation that confirms placement of the first order. Subsequently, if the user 110 accesses the user application 134, the user application may present the user interface 136 that displays the second merchants, e.g., on a map or as text information. In addition, the user interface 136 may notify the user 110 of a time limit for placing the bundled order, such as in the form of a countdown, or the like. In some examples, different time limits may be applied to different categories of items, such as based on predicted preparation times for the items.

The order processing program 140 may receive the selection of the additional item and may send the order information to the corresponding merchant. In addition, the order processing program 140 may send, to the agent device 120, bundled order information 157 indicating that the additional item 118(2) is to be picked up from the pickup location 124(2) of the second merchant and delivered with the first items 118(1) to the delivery location 126 Accordingly, the selected additional item 118(2) may be delivered to the user 110 by the same agent 120 that delivers the first item 118(1). Further, in some examples, the user 110 may be charged a single delivery fee for the bundled order, thus avoiding an additional delivery fee that may have been charged if the additional item 118(2) had been ordered separately from the first item 118(1).

For discussion purposes, the foregoing example is described with respect to an example system architecture. Other system architectures, computer system arrangements, and/or other distributed computing system configurations may be employed in other implementations herein, as will be apparent to those of skill in the art having the benefit of the disclosure herein.

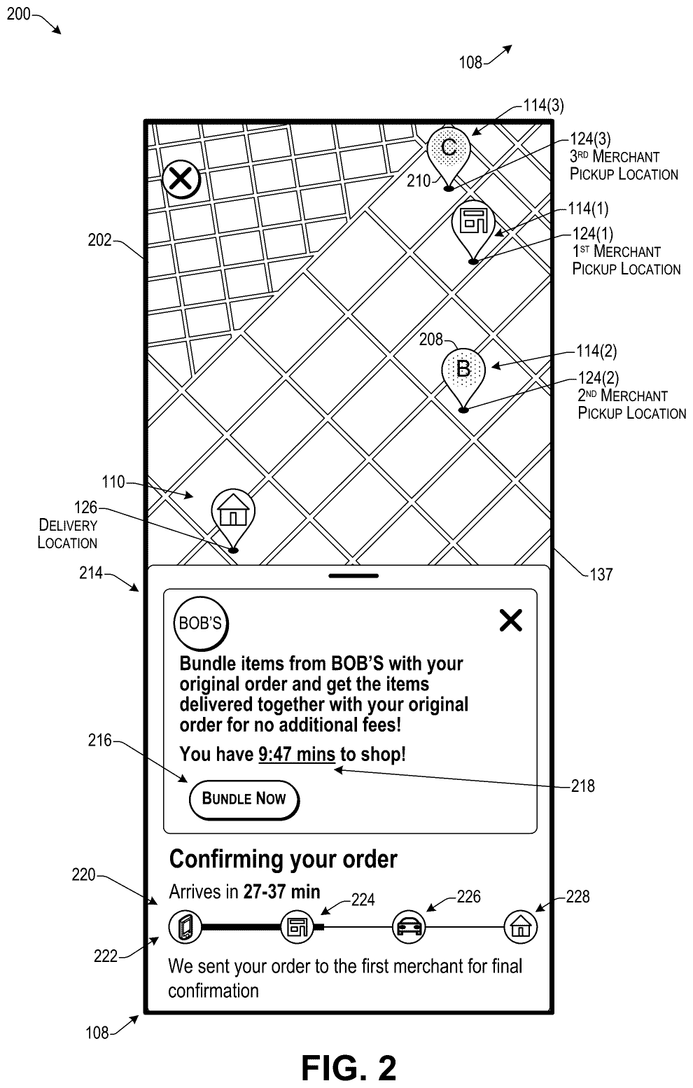

FIG. 2 illustrates an example user interface 200 that may be presented on display 137 of a user device 108 according to some implementations. For instance, the user interface 200 may correspond to the user interface 136 discussed above with respect to FIG. 1. In this example, suppose that the user 110, e.g., as discussed above with respect to FIG. 1, has used the user application 134 executing on the user device 108 to place a first order with a first merchant 114(1), e.g., “THE BURGER STORE”, for a first item 118(1). Following receipt of the first order from the user device 108, the service computing device(s) 102 (not shown in FIG. 2) may forward the order to the first merchant 114(1), and may determine one or more other merchants having pickup locations that meet a location criterion. As one example, the location criterion may include that the other merchants are at least one of: within a threshold distance of the first merchant pickup location 124(1); within a threshold distance of the delivery location 126; or in an area determined between the first merchant pickup location 124(1) and the delivery location 126.

In addition, as there could possibly be a large number of additional merchants in many urban and suburban areas, the service computing device(s) 102 may select a subset of the merchants that meet the location criterion, such as based on a likelihood that the user 110 will be interested in adding one or more additional items from the respective merchants for bundling with the first order. For example, the service computing device(s) 102 may apply rule-based heuristics, which may include machine learning, for selecting the subset of the merchants to display in the user interface 200 as likely to be of interest to the user 110 for bundling one or more additional items for delivery with the first order.

In this example, the user interface 200 includes a map 202 and may display, on the map 202, the first merchant pickup location 124(1) and the delivery location 126. The selected subset of additional merchants that have been selected as meeting the location criterion and having been determined based to likely be of interest to the user 110 for adding one or more additional items to the first order are displayed as pins on the map 202 in this example, but may be displayed as logos, icons, and/or other visual indicators in other examples. For instance, suppose that the service computing device(s) 102 has selected “BOB'S Convenience Store” and “CAO'S Drugstore” to include in the subset of merchants for presentation on the map 202 in the user interface 200. Accordingly, a pin or other indicator 208 having a logo, trademark, or other symbol for BOB'S Convenience Store may be displayed on the map 202 at a second merchant pickup location 124(2) corresponding to the location of BOB'S Convenience Store on the map 202. In some examples, BOB'S Convenience Store may correspond to the second merchant 114(2) discussed above with respect to FIG. 1. Similarly, a pin or other indicator 210 may be displayed on the map 202 at a third merchant pickup location 124(3) corresponding to the location of the Cao's Drugstore on the map 202. Thus, CAO'S Drugstore may correspond to a third merchant 114(3).

In some cases, any number of pins, icons, symbols, names, or other types of indicators of available additional merchants may be presented on the map 202. However, in some examples herein, the number of indicators presented on the map 202 may be limited to provide clarity in the user interface 200, so that the map and the other indicators are not entirely obscured. For example, if too many icons are presented, it may be difficult for the user 110 to select a particular one of the pins or other indicators, such as if the indicators are crowded too closely together. Accordingly, a subset of additional merchants to display on the map 202 may be selected based on a plurality of rules that may be applied for selecting the subset of particular additional merchants to display on the map 202 for a particular user. For instance, the selected additional merchants displayed in the user device user interface 200 may be customized for the particular user 110, such as based on characteristics of the user 110, past orders of the user 110, or any of various other factors, as discussed additionally below.

In the illustrated example, similar to the example discussed above with respect to FIG. 1, suppose that the user 110 initially selects the first merchant 114(1) that the user is interested in ordering from (e.g., THE BURGER STORE), selects one or more items from the first merchant 114(1), and places an order. In response, the service computing device(s) 102 may apply one or more rules for determining the set of additional merchants 114(2), . . . , having items that are compatible with the first order and from which the user 110 may select one or more additional items to create a bundled order in which the one or more additional items from an additional merchant are combined with the first item in the first order and which, by bundling, may be delivered to the delivery location 126 by a single agent 120.

In some examples, the compatible second items may include items that may be determined to complement the first item(s) in the first order, or which may otherwise be determined to be likely to be selected by the user 110 for creating the bundled order. Furthermore, compatible items may include items with short or zero preparation time to help avoid possible spoilage of the first item, which may be already being prepared while the user 110 is browsing the additional items.

In some cases, applying the rules for selection of the subset of second merchants may include execution of the machine-learning model 152 discussed above with respect to FIG. 1. The machine-learning model 152 may receive, as input, one or more characteristics about the user 110, the user's order (e.g., the first item in this example), the first merchant 114(1), combinations thereof, of the like. For example, the machine-learning model 152 may be trained using previously received transaction information for a large number of past orders, such as based on past transactions and order histories for various different users, items, and merchants, as well as based on various other factors, such as time of day, time of year, geographic location, and so forth. Additional details of selecting the subset of merchants are discussed below.

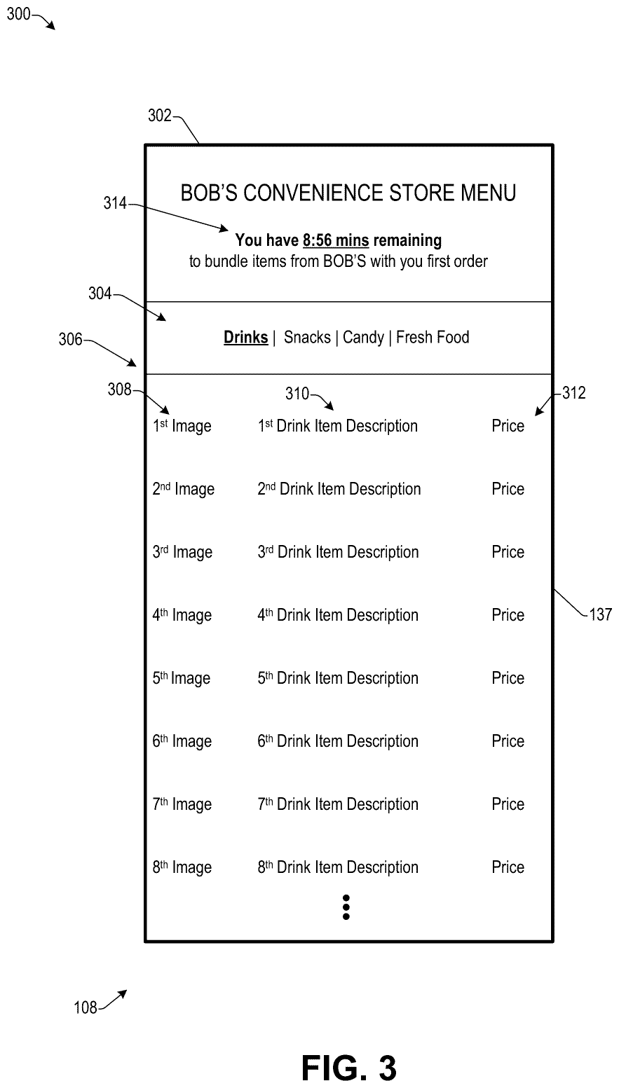

Following presentation of the selected subset of merchants on the map 202 in the user interface 200, the user 110 may tap on or otherwise select one of the indicators 208, 210 displayed on the map 202 to be presented with a banner 214. The banner 214 may provide information about the selected merchant (i.e., BOB'S in this example) and may invite the user to select one or more items from the selected merchant for bundling with the original order. For example, the user may select a “bundle now” virtual control 216 to be presented with a menu of items available from BOB'S, e.g., as discussed below with respect to FIG. 3.

Further, the user interface 200 indicates a time limit 218 for the user to select one or more items from the selected additional merchant for bundling with the first order. For instance, in this example, the user has 9 minutes and 47 seconds remaining in which to select an additional item from one of the additional merchants. As mentioned above, in some examples, the time limit may be established as a default time limit such as 5 minutes, 7 minutes, 10 minutes, or the like, so as to not unduly delay the first order. Furthermore, based on the time limit, the service computing device(s) 102 may delay assigning an agent to the first order to help ensure that the same agent 120 can be assigned to both the first order and to any bundled items selected by the user.

In other examples, the time limit may be displayed directly on the indicator 208, 210 for each second merchant. For instance, different time limits may be associated with different additional merchants depending on various factors such as location of the merchants and items offered by the merchants. For example, the time limit remaining for selecting the additional items may change dynamically as the user selects different merchants who may have different preparation times for various offered items or who may be in various different locations with respect to the first merchant pickup location 124(1), the delivery location 126, an agent location, or the like. For example, picking up a bag of chips from BOB'S Convenience Store may have a substantially lower preparation time than requesting and picking up an order of chicken wings from another restaurant. Accordingly, the time limit available to the user 110 for selecting an additional item for bundling may be substantially longer for selecting an item from BOB'S than for selecting the chicken wings from the other restaurant. Furthermore, as discussed additionally below, in some examples, individual items offered by each second merchant that have substantially different preparation times may have individual respective time limits for selection and, therefore, the menus presented to the user may update dynamically as items are removed from the menu during the passage of time as being no longer available for bundling.

In some examples, the user 110 may be able to tap on an area of the map 202, or may otherwise be provided with an additional button or other virtual control (not shown in FIG. 2) to view other additional merchants having items available for bundling and not initially presented on the map 202. For example, if the user 110 does not want items from BOB'S or CAO'S, the user 110 may have the option to request presentation of other additional merchants that may be available as an alternative to those already presented in the map 202. Alternatively, as another example discussed additionally below, rather than presenting the user interface 200 after the user 110 as already placed the first order, the user device 108 may initially present a user interface that enables the user 110 to select items from two or more different merchants as a bundled order before placing an order from any of the merchants.

Additionally, in the illustrated example, the user interface 200 further includes a current timeline 220 for the first order placed by the user 110. For instance, the timeline 218 may include an ordering icon 222, a merchant icon 224, an agent icon 226, and a user icon 228. Accordingly, the timeline 218 may provide a visual indicator of the current status of the first order, and may be associated with additional text that indicates a current estimated delivery time of the order and a textual statement of the status of the order.

FIG. 3 illustrates an example user interface 300 that may be presented on the display 137 of the user device 108 according to some implementations. For instance, the user interface 300 may correspond to the user interface 136 discussed above with respect to FIG. 1 in some cases. In this example, suppose that the user selected the “bundle now” virtual control 216 illustrated in the user interface 200 of FIG. 2. In responses, the user application 134 on the user device 108 may present the user interface 300 which includes a menu 302 of items offered by the selected second merchant, i.e., BOB'S Convenience Store in this example.

In the illustrated example, the menu 302 may include a plurality of selectable categories such as “Drinks”, “Snacks”, “Candy”, and “Fresh Food”. For example, rather than presenting a menu of all of the thousands of items typically available at a convenience store, the menu presented in the user interface 300 may include categories and items that are determined to be most likely to be selected by users who ordered items that are the same or similar to the item(s) included in the first order and/or by users who have user characteristics similar to the user 110 who placed the first order. In this example, suppose that the user has selected or has otherwise been presented with the “Drinks” menu items which includes a list 306 of a plurality of listed menu items, such as 1st through 8th drink menu items in this example. For instance, each listed menu item may include an image 308, a description 310, and a price 312. Further, the user 110 may swipe or otherwise scroll down to view additional items. Or may select alternative categories to view. In some examples, the user may further be presented with an option to view the complete menu for BOB'S Convenience Store, such as to select other items not included in the menu 302

In addition, the time limit for the user 110 to place an order for a second item from the selected merchant for bundling with the first order may be presented in the user interface 300, as indicated at 314. Alternatively, in other examples, a time limit may be associated with each individual menu item, rather than with the merchant overall. Accordingly, in such a case, menu items may be removed from the menu 302 as the time for ordering the respective menu item expires. This may result in the menu 302 being continually and dynamically updated based on the passage of time.

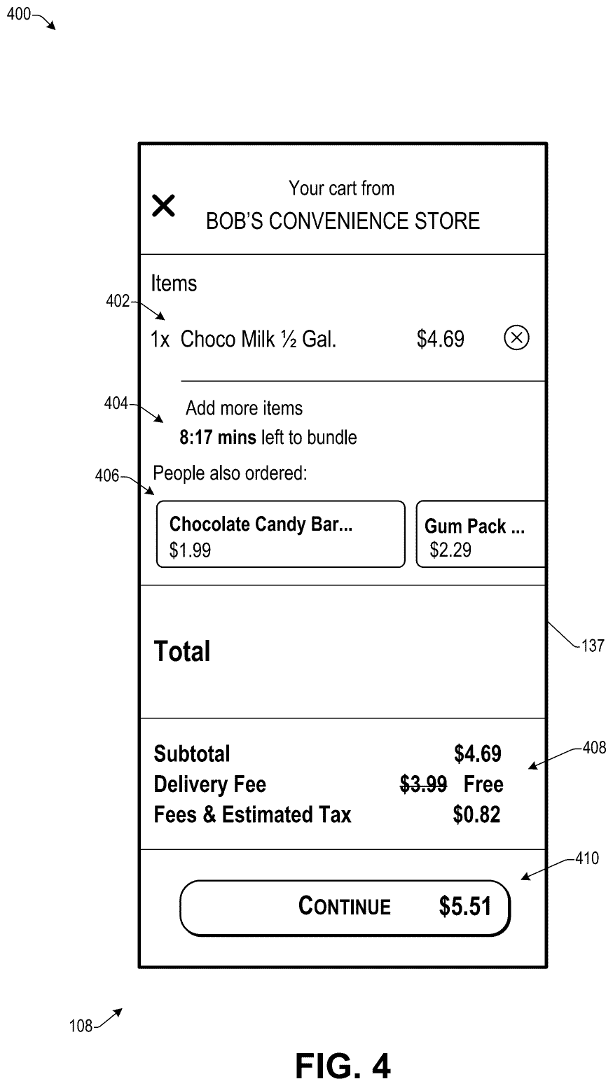

FIG. 4 illustrates an example user interface 400 that may be presented on the display 137 of the user device 108 according to some implementations. For instance, the user interface 400 may correspond to the user interface 136 discussed above with respect to FIG. 1. In this example, suppose that the user 110 has selected an item from the menu in the user interface 300 discussed above with respect to FIG. 3, e.g., a half-gallon of chocolate milk. To check out, the user application 134 may present the user interface 400, which shows the selected item and price, as indicated at 402. The user interface 400 further shows the amount of time remaining for the user to bundle the selected item and any other desired items as indicated by the time limit at 404. In addition, as indicated at 406, the user interface 400 may recommend one or more additional items that are likely to be ordered by a user who has selected the first item(s) in the first order and/or the second item 402. The user interface 400 may further include a subtotal, delivery fee, and estimated tax, as indicated at 408. For example, since the selected item 402 is being bundled with the first order, the delivery fee may be reduced or eliminated in some cases. If the user desires to proceed with ordering the selected item, the user may select a “continue” virtual control 410 for adding the total amount for the selected item to the amount already charged for the first order.

In addition, in some examples, if the time limit 404 has not yet expired, the user 110 may return to a previous menu such as to order additional items from the same merchant or from a different merchant, such as CAO'S Drugstore in the example of FIG. 2. Alternatively, in other examples, the user 110 may only be permitted to select additional items for bundling from one of the additional merchants presented in FIG. 2 to prevent an undue burden on the agent 120. Accordingly, when this is the case, the user interface 200 in FIG. 2 may present a message to inform the user 110 that only items from one additional merchant may be selected for creating a bundled order.

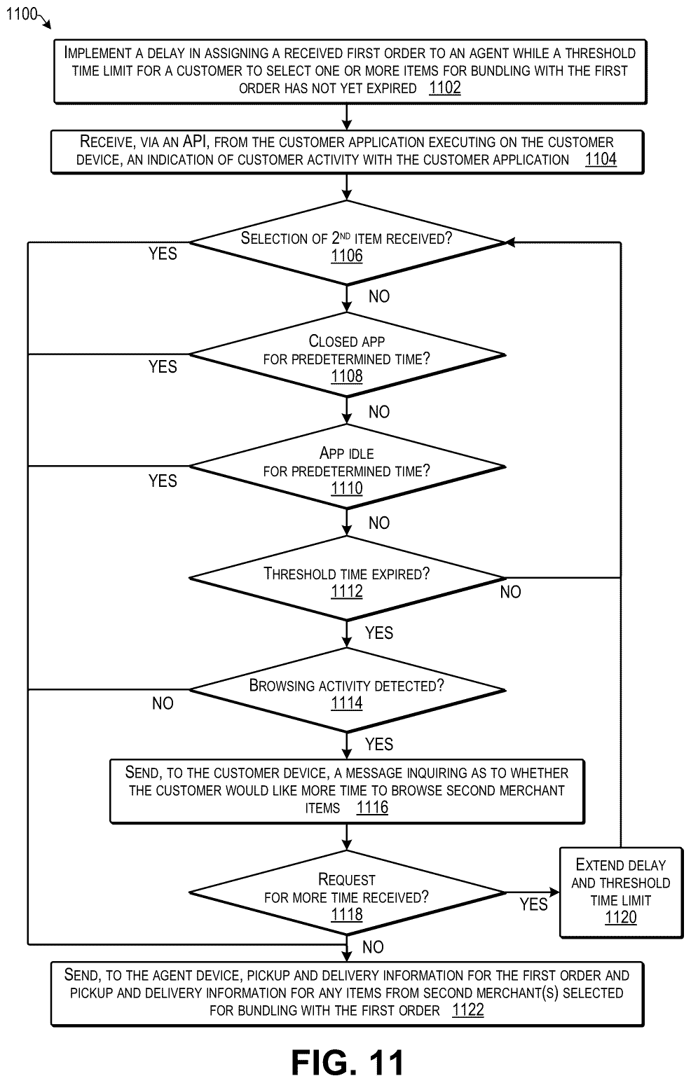

When the user 110 has confirmed the selection of one or more items for creating the bundled order, in some cases, the service computing device 102 may proceed with assigning the bundled order to an agent 120 for pickup and delivery. For instance, as one example, the service computing device 102 may assume that the remaining time limit can be discarded and that any delay imposed on assigning the first order and the bundled order to an agent can be terminated. Alternatively, in other examples, the service computing device 102 may continue to monitor the interaction of the user 110 with the user application 134 to determine whether to proceed with assigning the bundled order to an agent 120 or to wait until the end of the specified time limit 402 before assigning the orders to an agent. Additional details regarding the process for determining whether to maintain or terminate the delay are discussed below with respect to FIG. 11.

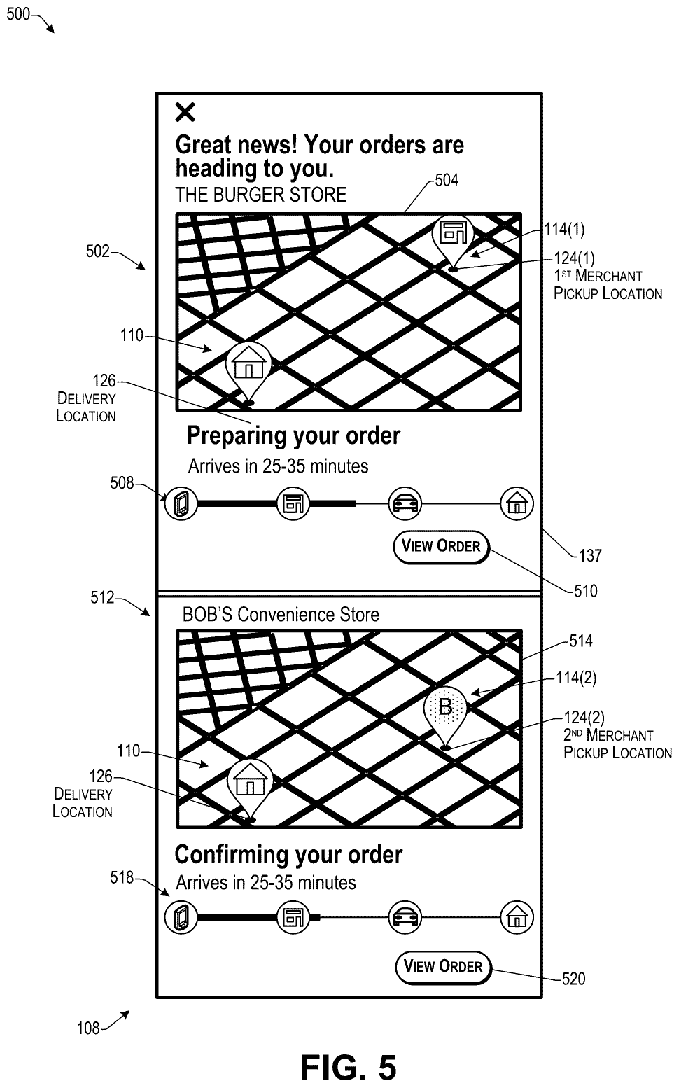

FIG. 5 illustrates an example user interface 500 that may be presented on the display 137 of the user device 108 according to some implementations. For instance, the user interface 500 may correspond to the user interface 136 discussed above with respect to FIG. 1. The user interface 500 may be presented on the user device 108 after the user has selected and confirmed the purchase of an additional item from one of the additional merchants discussed above for bundling with the first order. In this example, suppose that the user 110 has added an item from BOB'S Convenience Store and that the agent 120 will pick up the item from BOB'S Convenience Store after picking up the first item ordered from the first merchant 114(1), i.e., THE BURGER STORE in this example.

The user interface 500 may display information related to the status of the first order and the second order. For instance, a first user interface portion 502 may present a first map 504 showing the first merchant pickup location 124(1) relative to the delivery location 126. In addition, if an agent has been assigned and accepted the delivery job, the first map 504 may also show a current agent location 506 relative to the first merchant pickup location 124(1) and the delivery location 126. In addition, the first user interface portion 502 may present a current timeline 508 showing a timeline status indicating whether the agent has picked up the first item from the first merchant and the estimated arrival time of the agent at the delivery location 126. The first user interface portion 502 may further include a selectable virtual control 510 that the user may select to view details of the first order.

Similarly, a second user interface portion 512 may include a second map 514, illustrating the second merchant pickup location 124(2) relative to the delivery location 126. In addition, a timeline 518 may show a status of preparation of the second order and the estimated arrival time of the bundled order at the delivery location 126. For instance, after the agent 120 picks up the first order from the first merchant 114(1), the location of the agent 120 may be presented on the second map 514 relative to the second merchant pickup location 124(2) before, during, and after pickup of the second item from the second merchant pickup location 124(2) and up until arrival of the agent 120 at the delivery location 126. The second user interface portion 512 may further include a selectable virtual control 520 that the user may select to view details of the second order.

Furthermore, the first order placed may not necessarily be the first order picked up by the agent 120. For example, depending on the agent location relative to the first merchant location 124(1), the second merchant location 124(2), and the timing at which the first order and second order are placed, the second order may be picked up by the agent 120 before the first order is picked up. Additionally, in some examples, a third order or fourth order from other respective additional merchants may also be bundled with the first order and picked up by the agent 120, depending on the nature of the additional items ordered and the locations of the respective additional merchants. In such a case, the user interface 500 may be scrollable to determine the respective statuses of the third and fourth orders.

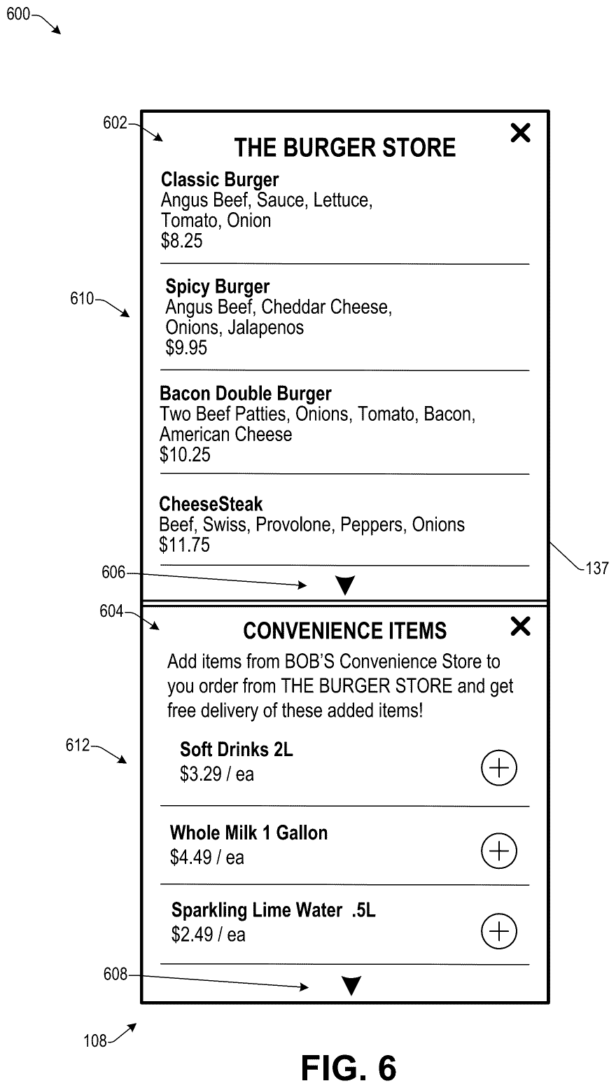

FIG. 6 illustrates an example user interface 600 that may be presented on the display 137 of the user device 108 according to some implementations. For instance, the user interface 600 may correspond to the user interface 136 discussed above with respect to FIG. 1. In the example of FIG. 6, rather than presenting the user interface 200 of FIG. 2 after the user has already placed the first order, the user application 134 may be configured to present the user interface 600 which may present items offered by a selected first merchant as indicated at 602 as well as items offered by a second merchant, as indicated at 604, that are available for bundling with items ordered from the first merchant. In some instances, as indicated by arrows 606 and 608, respectively, the user 110 may separately scroll through the items 610 offered by the first merchant 602 and the items 612 offered by the second merchant 604.

To generate the user interface 600, when the user 110 selects the first merchant 602 (i.e., THE BURGER STORE in this example) for browsing items 610 offered by the first merchant 602, the user application 134 may concurrently present information about the second merchant 604 having items 612 suitable for bundling with the items 610 of the selected first merchant 602, and may further present an incentive for creating a bundled order such as free delivery of the items 612 from the second merchant 604 when bundled with items 610 from the first merchant 602.

As one example, when the user application 134 detects that the user 110 has selected the first merchant 602 for browsing, the user application 134 may send, by the one or more APIs 131, a communication to the service computing device 102 indicating that the user is browsing items 610 offered by the first merchant 602. In response, the service computing device 102 may determine one or more second merchants that can be bundled with the first merchant 602 based on the respective locations of the first merchant 602, the one or more second merchants, and the user's current location and/or default delivery address. In addition, the service computing device 102 may determine items offered by the candidate second merchants that are compatible with, or otherwise frequently purchased by users with, the items 610 offered by the first merchant 602. The service computing device 102 may select the second merchant 604, and a menu of the second merchant 604, and send in real time, via the API(s) 131, the selected second merchant information and menu information to the user device 108. The user application 134 may receive and present the information about the second merchant 604 and the items 612 available for bundling with the items 610 from the first merchant 602 selected by the user.

Additionally, or alternatively, in some examples, the second merchant 604 and items 612 for bundling with the first merchant 602 may be determined in advance for the delivery location of the user 110 and stored at the user application 134 on the user device 108, rather than being determined and communicated over the network(s) 106 in real time via an API. For instance, the bundling program 150 may determine, for individual merchants participating in the service provided by service computing device(s) 102, one or more second merchants within a predetermined distance from the individual merchant, and may further determine which items of the one or more second merchants are likely to be paired with items offered by the individual merchants. Accordingly, because the selected merchants are within a sufficiently close distance of each other, bundles from such paired merchants may be offered through the user interface 600 even before the user selects a first merchant, and regardless of the delivery location of the user.

In either event, the user 110 may select items from the first merchant 602 and the second merchant 604, and may checkout the order as a single bundled order. In response, the service computing device(s) 102 may receive the bundled order information from the user device 108, and may send the order information to the respective first and second merchants. In addition, the service computing devices 102 may proceed with assigning an agent 120 for delivery of the bundled order, such as upon receipt of confirmation from the respective first and second merchants, rather than waiting for a delay period as in the previous examples discussed above.

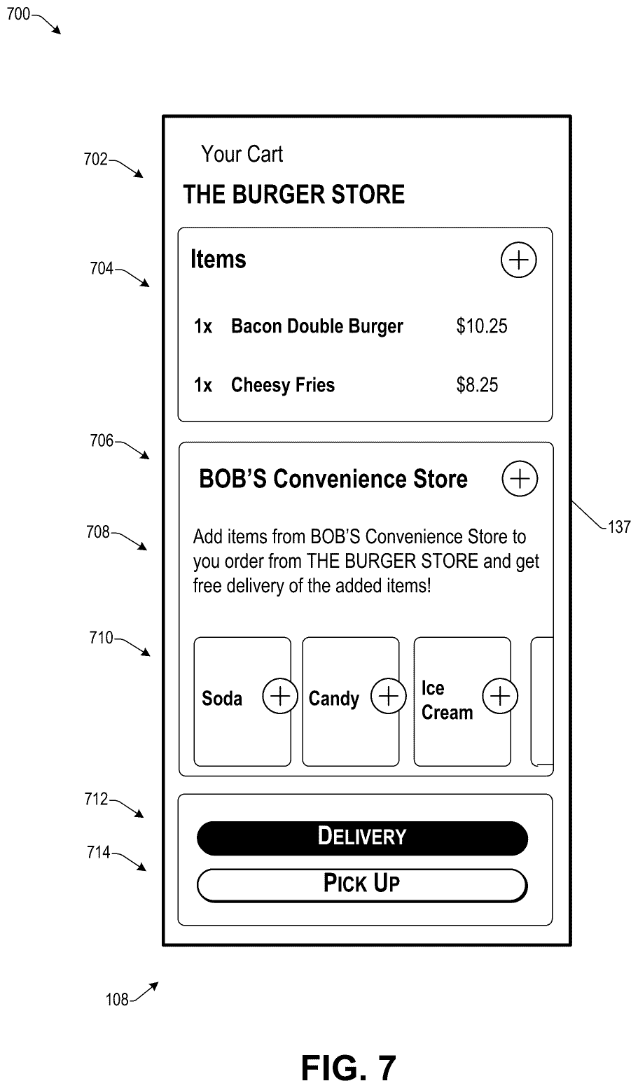

FIG. 7 illustrates an example user interface 700 that may be presented on the display 137 of the user device 108 according to some implementations. For instance, the user interface 700 may correspond to the user interface 136 discussed above with respect to FIG. 1. In this example, rather than presenting the additional merchant information for bundling during browsing of the first merchant, the merchant information for bundling may be presented in the user's cart when the user is preparing to check out. Accordingly, the user interface 700 includes an indication of the first merchant 702, and items 704 selected by the user from the first merchant 702 and corresponding prices. In addition, the user interface 700 presents a selected second merchant 706, i.e., BOB'S Convenience Store, along with a message 708 that the items in the item categories 710 from the second merchant 706 may be bundled with the selected items 704 from the first merchant 702.

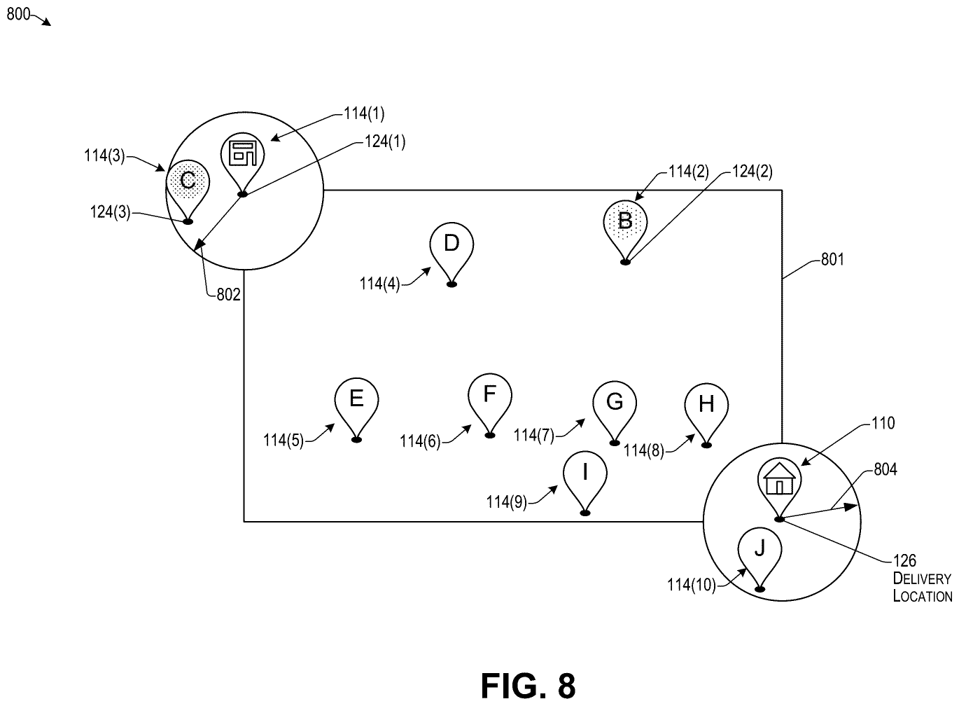

In this example, the second merchant may be selected by the service computing devices 102 using the techniques discussed above with respect to FIG. 6. For instance, the second merchant 706 and item categories 710 to offer may be determined in real time via API communications between the user application 134 on the user device 108 and the service computing device(s) 102. Alternatively, the second merchant 706 and items categories 710 may be determined in advance such as by determining the first merchant and one or more second merchants within a predetermined distance of each other, such as discussed additionally below with respect to FIG. 8.

The user 110 is able to browse the items offered from the second merchant such as by tapping on one of the displayed item categories or the like. When the user 110 has completed selecting a second item for bundling with the first items 704, the user 110 may select a “delivery” button 712 to proceed with checkout and have the selected items delivered as a bundled order. Alternatively, if the user 110 would like to pick up the ordered items, the user 110 may select a “pick up” button 714, pay for the selected items as a bundled order, and pick up the items from the respective first and second merchants.

Furthermore, while two examples of techniques for enabling the user 110 to select items from two or more different merchants as a bundled order before placing an order from any of the merchants are discussed above with respect to FIGS. 6 and 7, other techniques will be apparent to those of skill in the art having the benefit of the disclosure herein. As one example, a homepage of the consumer application may immediately surface bundled combinations of items that may have been determined in advance by the service computing device(s) 102. For instance, the home page may display “Frequently ordered together” bundles from two different merchants, e.g., a burger from THE BURGER STORE and a bottled soft drink from BOB'S Convenience Store may be displayed as a bundle immediately available for selection and checkout.

As another example, the user 110 may be presented with homepage including a map similar to that shown in FIG. 2 showing merchant indicators having items that can be bundled together, or alternatively, with a list of paired merchants, etc., who offer items that are combinable into a single bundled order, such as for a single delivery fee. Each of these techniques may enable the user to select all the items desired for a bundled order before placing the order, and the user 110 is therefore not under a time constraint to add a second item to an order that has already been placed for a first item.

FIG. 8 illustrates an example diagram 800 for determining additional merchants that meet a location criterion for bundling items with an order of a first merchant according to some implementations. As one example, following receipt of an order from the user 110 for a first item to be prepared by a first merchant 114(1), the bundling program 150 may be executed to determine one or more additional merchants 114(2), 114(3), . . . , having a pickup location 124(2), 124(3), . . . , respectively, that are at least one of: (1) within a threshold distance of the pickup location 124(1) of the first merchant 114(1), (2) within a threshold distance of the delivery location 126 of the user 110, or (3) within a quadrilateral 801 formed between the pickup location 124(1) and the delivery location 126.

As one example, a first radius 802 may be established around the first merchant pickup location 124(1) as a first threshold distance, and a second radius 804 may be established around the delivery location 126 as a second threshold distance. For instance, the first threshold distance may be determined based on a predicted agent travel time from the first pickup location 124(1) to the edge of the circle established by the first radius 802 being less than a threshold time, such as five minutes or less. The second threshold distance for the second radius 804 may be similarly determined. As one consideration, the threshold distances may be selected to not add a substantial additional burden to the agent and/or to not add substantial additional travel time from the first pickup location 124(1) to the delivery location 126. Typically, the first radius 802 and the second radius 804 may be approximately the same distance, such as about 1 to 2 miles in an urban setting and 2-3 miles in a suburban or rural setting.

In addition, in some examples, the quadrilateral 801 may be established based on a difference in longitude and latitude of the first merchant pickup location 124 and the delivery location 126. In other examples, such as if the first merchant pickup location 124 and the delivery location 126 are located on approximately the same latitude or the same longitude, the size of the rectangle may be limited in its shortest dimension to a maximum of three times the larger of the first radius 802 or the second radius 804.

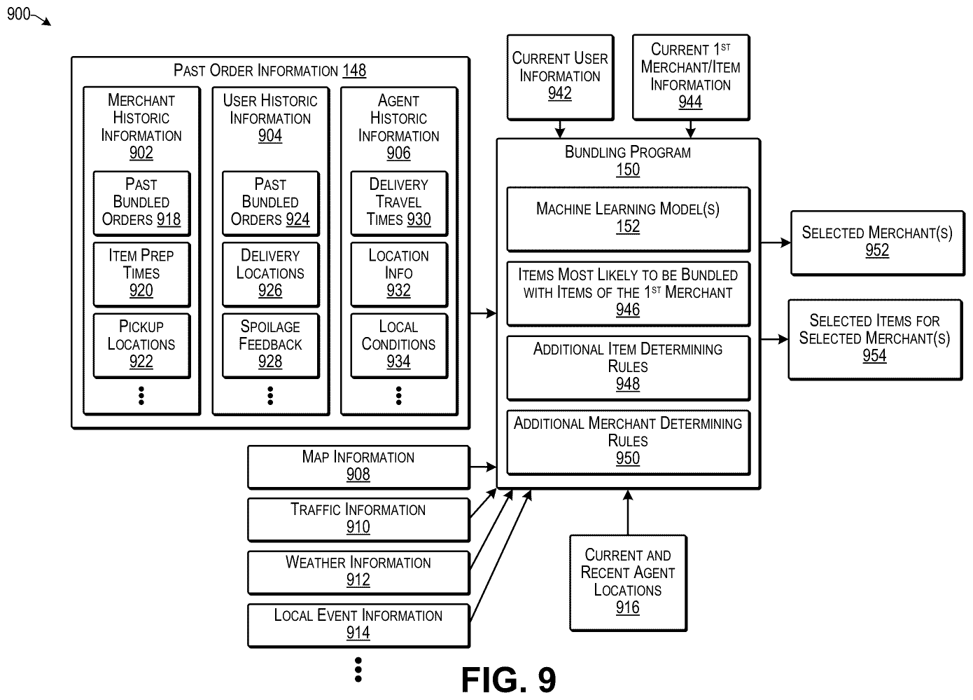

The service computing device(s) 102 may determine all additional merchants within the three areas specified above such as overlaying the above described diagram onto a map or the like, or otherwise by cross-referencing with mapping information, e.g., by determining the longitudes and latitudes of the three areas and determining any merchants longitudes and latitudes within those areas. In this example, suppose that the service computing device(s) 102 identified nine additional merchants B-J 114(2)-114(10), respectively. Based on identifying the plurality of additional merchants 114(2)-114(10), the bundling program 150 may further apply other rules for selecting a subset of the additional merchants B-J 114(2)-114(10), respectively, to present on the user device 108, e.g., as discussed below with respect to FIG. 9.

Furthermore, when determining agent travel times, such as for determining an appropriate first radius 802 and second radius 804, the bundling program 150 may take into consideration actual travel times determined from the past order information 148 and various other factors, such as traffic, weather, local events, date, etc. Based at least in part on these considerations, the bundling program 150 may predict agent travel times between the first pickup location 124(1) and various other locations and/or between the delivery location 126 of the user 110 and various other locations. Additionally, in other examples, rather than using simple geometric constructs such as radii 802, 804, and the quadrilateral 806, the bundling program 150 may determine more exact mappings to specific streets based on actual predicted travel times to a large plurality of points around the first pickup location 124(1), the delivery location 126, and a shortest route between the two.

Furthermore, in some examples, an agent location who will be handling the bundled order may be determined in advance. In this situation, one or more of the selected second merchants may be at a location between the agent location (or a current agent destination) and the first merchant pickup location 124(1). In such a case, the location of the particular second merchant relative to the agent location and the first merchant location may typically provide a smaller time window for the user 110 to decide whether to select an item from this particular second merchant than for merchants located near a route between the first merchant location 124(1) and the delivery location 126.

FIG. 9 is a conceptual block diagram 900 illustrating an example of determining merchants and items to present on a user device for enabling bundled orders according to some implementations. In this example, the bundling program 150 may be executed by the service computing device(s) 102 to receive the past order information 148 including merchant historic information 902, user historic information 904, and agent historic information 906. In addition, the bundling program 150 may receive map information 908, traffic information 910, weather information 912, local event information 914, and/or current and recent agent location information 916. Further, while several types of information that may be used by the bundling program 150 are illustrated, in other examples, other or additional types of information may be used by the bundling program 150, as discussed above, and/or as will be apparent to those of skill in the art having the benefit of the disclosure herein.

The merchant historic information 902 includes historic order information related to merchants, e.g., various types of information related to past orders filled by the merchants that participate in the service of the service provider 104. For instance, the merchant historic information 902 may include past bundled orders 918 for each merchant, e.g., which items of which merchant were bundled with which items of other merchants at particular times on particular days of the week, particular dates, how many of each item was ordered, and so forth. Further, the merchant historic information 902 may include actual item preparation times 920 for each item offered by each merchant and the pickup locations 922 associated with each merchant. As one example, each merchant may initially specify an expected preparation time for each item or each category of item offered by the merchant. In some cases, the merchants or the service provider may categorize items into preparation-time-based item categories, such that items having a similar preparation times are categorized into the same item category. Subsequently, as the service provider determines actual item preparation times for particular items offered by each merchant, and additional information such as the individual merchant's order load when the preparation times are determined, the bundling program 150 may use a current merchant order load to determine a predicted preparation time for a current order.

Additionally, the user historic information 904 includes historic order information related to the users. Examples of user historic information 904 may include past bundled orders 924, e.g., bundled orders made by individual users at particular times of day, days of the week, and dates on which each order was placed. The user historic information 904 may further include delivery locations 926 to which each order was delivered, and spoilage feedback 928. For instance, feedback may be received from the user devices that may indicate if one or more items from an order spoiled prior to delivery to the user. Spoilage may be indicated by items that are considered to be of a degraded quality. This spoilage feedback 928 may be used to adjust or otherwise change certain thresholds used herein. For example, if spoilage feedback 928 is received for a first item in an order in which a bundled item was obtained from a second merchant within a threshold distance of the first merchant, or from a second merchant within a threshold proximity of the agent travel route, this spoilage feedback 928 may indicate that the threshold distance or threshold proximity, respectively, might need to be reduced to avoid spoilage of the first ordered item.

Further, the agent historic information 906 includes historic order information related to the agents. For example, the agent historic information 906 may include delivery travel times 930, which may indicate the time that an order was picked up and the time that the order was delivered, e.g., how long it took each agent to arrive at a delivery location after picking up the order from the merchant's pickup location. Additionally, location information 932 may include locations of individual agents at different times of day, for different days of the week in different parts of the service region. For instance, the agent location information 932 may indicate speeds at which agents are able to travel on different streets in the service region at different times of day, thereby providing an indication of traffic information and an indication of predicted delivery travel times at different times of day and different days of the week. The location information 932 may further indicate how far each agent had to travel after picking up each order to make delivery of the order.

In some examples, the agent application may automatically send agent locations 916 to the bundling program 150 on a periodic basis while the associated agent is on-duty or otherwise active. Alternatively, the bundling program 150 may periodically ping the agent devices 121 of active agents to determine the agents' current locations. The received agent locations 916 may indicate current agent travel speeds and conditions, and may be stored as location information 932. Each agent device may include one or more location sensors, such as a GPS receiver, and/or communication interfaces that can determine (e.g., from cell towers or wireless access points) a geographic location of the agent device.

In addition, the agent historic information 906 may include local conditions 934, such as traffic conditions and weather conditions when particular orders were fulfilled, information regarding any local events taking place within the service region when the orders were fulfilled, and the like. Furthermore, the merchant historic information 902, the user historic information 904, and the agent historic information 906 may include additional types of information, with the foregoing being merely several examples of the types of information that may be used by the bundling program 150.

In some implementations, the bundling program 150 may employ one or more machine learning models 152 for determining additional merchants and items to present to a user for possible bundling with items of a first merchant based on detecting the user's interest in ordering one or more items from the first merchant. As mentioned above, the machine learning model(s) 152 may include one or more trained models that account for numerous pieces of information included in the past order information 148, as well as current information as inputs, such as time, day and date information, current user information 942, and current first merchant and item information 944. In some cases, the machine learning model(s) 152 may be initially trained using a set of training data, checked for accuracy, and then used for predicting items most likely to be selected by the current user for bundling with the items selected from the first merchant, or, in other cases, the items available from the first merchant. The machine learning model(s) 152 may be periodically updated and re-trained based on new training data to keep the machine learning model(s) 152 up to date and accurate. Suitable machine-learning models 152 may include predictive models, decision trees, classifiers, regression models, such as linear regression models, support vector machines, stochastic models, such as Markov models and hidden Markov models, and artificial neural networks, such as self-organizing neural networks, recurrent neural networks, convolutional neural networks, modular neural networks, deep-learning neural networks, and so forth.

The machine learning model(s) 152 may receive the current user information 942 as input. Examples of current user information 942 may include any past bundled orders made by the user, as well as past non-bundled orders, and any other known characteristics of the user that may be matched with similar characteristics of other users who have bundled orders in the past from the same or similar merchants as the current first merchant. As one example, the machine learning model(s) 152 may output an indication of items 946 most likely to be bundled with the items of the first merchant.

In addition, in some examples, the bundling program 150 may determine a set of merchants that meet the location criterion for being sufficiently close to at least one of the first merchant pickup location, the delivery location, and/or within a threshold proximity to the predicted agent travel route, such as by using the technique discussed above with respect to the example of FIG. 8, or by other suitable techniques. Further, the bundling program may input the items offered by these merchants into the machine learning model(s) 152 so that the output items 946 are limited to items available from the set of merchants that meet the location criterion.

The bundling program 150 may further apply additional item determining rules 948 for determining the items most likely to be selected by the current user for bundling with the items from the current first merchant. As one example, if the user has ordered items in the past from the first merchant, any items bundled with these orders by the current user in the past may be assigned a highest probability in the items 946. For example, the items listed in the items 946 may be ranked from a higher probability to a lower probability. As such, items bundled in the past by the current user may be assigned a highest probability if not already done so by the machine learning model(s) 152.

In some cases, based on the determination of the items 946 most likely to be bundled with the items of the first merchant for the current user information 942 and current first merchant information 944, the bundling program 150 may apply additional merchant determining rules to determine one or more merchants able to provide the items included in the items 946 most likely to be bundled with items of the first merchant. In some examples, the additional merchant determining rules 950 may include one or more algorithms, one or more machine learning model(s) 152, a plurality of decision-making rules, or the like, configured to determine one or more selected merchants 952 to present on the user device 108 for enabling the current user to bundle additional items with one or more items of the current first merchant. For example, for the plurality of merchants that meet the location criterion, the items offered by the respective merchants may be compared with the items 946 most likely to be bundled by the user with the items of the first merchant.

In some cases, the additional merchant determining logic 950 may attempt to match the highest ranked items in the items 946 first, such as for attempting to ensure that items bundled by the current user in the past can be made available for bundling with the current order. Based on the comparing, the bundling program 150 may output one or more selected merchants 952 and, for the one or more selected merchants, may output selected items 954 for the selected merchants 952. For example, in the case that the selected merchant 952 has a large number of items, such as in the case of a convenience store, drug store, grocery store, etc., the selected items 954 may enable the bundling program 150 to determine which of the items of the selected merchant 952 to prioritize for presenting in the user interface on the user device. As discussed above, the selected merchant(s) 952 and selected items 954 for the selected merchants may be sent to the user device 108, such as in any of the examples discussed above with respect to FIGS. 1-7.

Furthermore, in other examples, rather than determining items most likely to be bundle by the particular user with the items of the particular first merchant, the bundling program 150 may merely determine items of the set of merchants that meet the location criterion that are most likely to be bundled by most people with most orders, and may select those merchants offering the most of those items as the selected merchants 952. Additionally, while the machine learning model(s) 152 has been described as one example of a technique for determining items 946 most likely to be selected for bundling by a current user, numerous other techniques, algorithms, decision-making rules, and the like, may additionally, or alternatively, be used for determining this information. Accordingly, implementations herein are not limited to use of the machine learning model(s) 152. Further, while several techniques for determining additional merchants and items to present to a user for bundling has been described above, numerous variations will be apparent to those of skill in the art having the benefit of the disclosure herein.

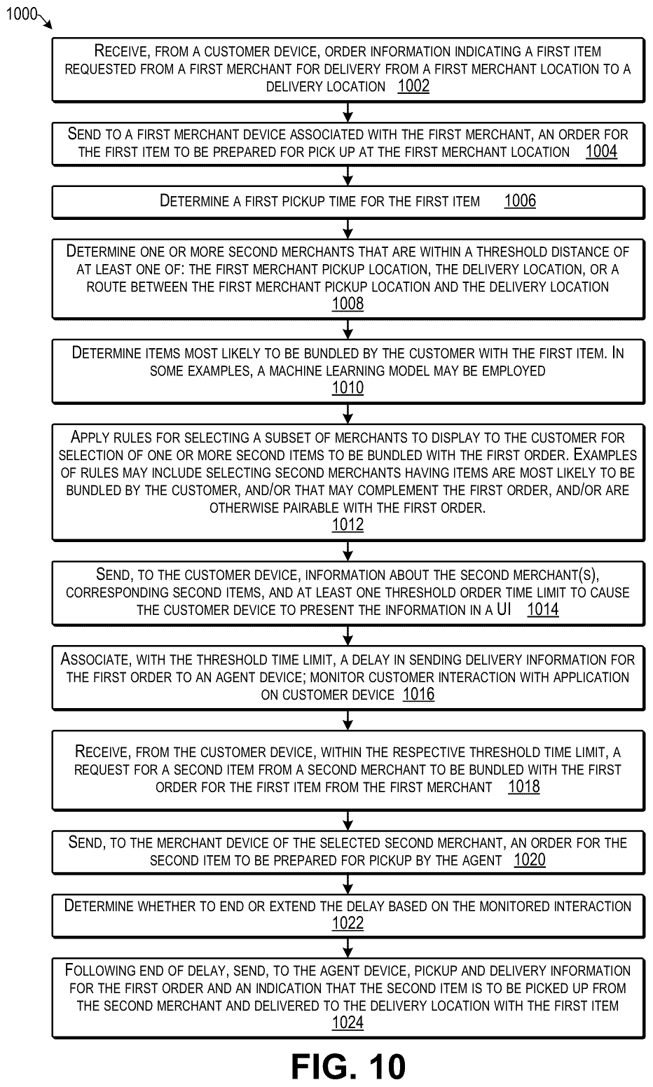

FIGS. 10 and 11 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems and devices described in the examples herein, although the processes may be implemented in a wide variety of other environments, systems and devices.

FIG. 10 is a flow diagram illustrating an example process 1000 for rule-based bundling for logistical efficiency according to some implementations. In some examples, the process 1000 may be executed in part by the service computing device(s) 102 executing the bundling program 150 and in part by the user device 108 executing the user application 134.

At 1002, the service computing device may receive, from a user device associated with a user, order information indicating a first item requested from a first merchant for delivery from a first merchant location to a delivery location. For instance, the service computing device may receive, from the user device, an indication of the delivery location, and may send, to the user device, item information about items offered by a plurality of merchants that are available for delivery to the delivery location. The user device may present the item information on a display of the user device to enable the user to select and place an order for a first item from a first merchant of the plurality of merchants.

At 1004, the service computing device may send to a first merchant device associated with the first merchant, an order for the first item to be prepared for pick up at a first merchant pickup location associated with the first merchant. Alternatively, in other examples, the first order is not sent immediately to the first merchant, but may instead be held for a period of time to allow the user additional time to determine a second order from a second merchant. As one example, the user interface on the user device may give the user an option to elect to hold the first order for a specified amount of time while the user browses second merchants that have been surfaced by the user interface as being compatible with the first order. This may reduce or eliminate time constraints on the user for selecting a second item from a second merchant within a specified time period. In addition, this may also make it more efficient for an agent to pick up the second order before picking up the first order in some cases. As still another example, rather than receiving an order, the service computing device may receive an indication that the user is browsing a first merchant, and in response, the service computing device may send information about one or more second merchants and associated items to present on the buyer device for enabling the user to create a bundled order from the start, rather than after placing the first order.

At 1006, the service computing device may determine a first pickup time for the first item. In some examples, the service computing device may receive merchant information from the first merchant device indicating the first merchant's predicted preparation time for the first item and an associated pickup time based on the preparation time. In other examples, the service computing device may receive merchant information from the first merchant device indicating a current load of orders being fulfilled by the first merchant. The service computing device may compare the current load with past workloads and may determine item preparation times associated with similar past workloads to determine a predicted item preparation time and associated pickup time for the first item.

At 1008, the service computing device may determine one or more second merchants that meet a location criterion by having a respective pickup location within a threshold distance of at least one of: the first merchant pickup location; the delivery location; or a route between the first merchant pickup location and the delivery location. For instance, as discussed above, e.g., with respect to FIG. 8, the threshold distances may be based at least in part on predicted agent travel times, such as from the first merchant location to the locations of the second merchants and to the delivery location.

At 1010, the service computing device may determine items most likely to be bundled by the user with the first item from the first merchant. In some examples, a machine learning model may be employed as discussed above, e.g., with respect to FIG. 9 for determining items from among the items available from the plurality of second merchants that meet the location criterion. As discussed above, in some cases, the items may be ranked according to a likelihood of being selected by the user for bundling with the first item from the first merchant.

At 1012, the service computing device may apply rules for selecting a subset of the merchants to display to the user for selection of one or more second items to be bundled with the first order. Examples of rules may include selecting second merchants having items that are most likely to be bundled by the user, and/or that may complement the first order, and/or are otherwise pairable with the first order. In some cases, a series of rules may be applied to determine cuisine compatibility between the first item selected for the first order and other items available from the second merchants identified at 1008 above. Further, the past orders of the particular user and/or other users having characteristics similar to the current user may be analyzed for determining likely second merchants and/or items that the user would be likely to add for bundling with the first order.

In addition, some merchants, such as convenience stores, drugstores, grocery stores, and the like, may offer a wide array of items that may be desired by a user, and the inclusion of one or more of these merchants in the subset may provide the user with an opportunity to select one or more additional items likely to be of interest. Further, in some examples a machine-learning model may be applied for selecting the subset of second merchants and/or items to offer to the user, as discussed above with respect to FIG. 9. Additionally, in some examples, the current or predicted locations of agents may be taken into consideration for determining which second merchants to present to the user in the user interface. For example, if an agent that is predicted to be heading in the direction of the first merchant will be passing a particular second merchant having items that may be compatible with the first order, that second merchant may be included in the presented second merchants, whereas if the agent was approaching from a different direction, that particular second merchant might not be included.

At 1014, the service computing device may send, to the user device, information about at least the selected subset of second merchants, corresponding second items, and at least one threshold order time limit to cause the user device to present the information in a user interface. In some cases, the user device may be programmed to present the selected second merchants on a map in the user interface, such as discussed above with respect to FIG. 2, and may also provide some indication of the at least one threshold order time limit under which the user is allowed to order the respective additional items for bundling. Sending the information to the user device may cause, at least in part, the user device 108 to present the user interface, such as a user interface similar to the user interface 200 discussed above with respect to FIG. 2. In addition, when the user selects a particular second merchant, the user interface may present a menu of items available from the selected merchant, such as the user interface 300 discussed above with respect to FIG. 3.

At 1016, the service computing device may associate, with the at least one threshold time limit, a delay in sending the order and delivery information for the first order to an agent device. For example, as mentioned above, the service computing device may delay assigning an agent to the first order to attempt to ensure that the same agent is available to deliver both the first order and any order bundled with the first order together to the delivery location to ensure efficiency in the bundling service. Based on the implementation of the delay, the service computing device may monitor user interaction with the user application on user device, such as based on receiving communications from the user application via one or more APIs 131 as discussed above. Additional details of the monitoring are discussed below with respect to FIG. 11.

At 1018, the service computing device may receive, from the user device, within the respective threshold order time limit, a request for a second item to be obtained from a second merchant and to be included as a bundled order that is bundled with the order for the first item from the first merchant. In some examples, if the user attempts to order an item from one of the second merchants after expiration of the associated threshold time, a new order may be created that is not bundled with the first order for the first item.

At 1020, the service computing device may send, to the merchant device of the selected second merchant, an order for the second item to be prepared for pickup by an agent.

At 1022, the service computing device may determine whether to end, maintain, or extend the delay based on the monitored interaction of the user with the user application on the user device. See, e.g., FIG. 11 for additional details.

At 1024, following the end of the delay, the service computing device may send, to the agent device, pickup and delivery information for the first order and an indication that the second item is to be picked up from the second merchant and delivered to the delivery location with the first item as a bundled order. Thus, the agent may deliver the first item and the second item to the delivery location together in a single delivery.

FIG. 11 is a flow diagram illustrating an example process 1100 for managing a communication delay based on detecting remote interaction on a user device according to some implementations. In some examples, the process 1100 may be executed in part by a service computing device(s) 102 and in part by the user device 108. The process 1100 may be performed as part of the process 1000 discussed above with respect to FIG. 10. For instance, by implementing the threshold time limit and implementing a delay in assigning an agent, the logistical efficiency of the system can be improved for ensuring that the same agent can be used for picking up and delivering the first order as well as for picking up and delivering any additional items that the user may decide to bundle with the first order.

At 1102, the service computing device may implement a delay in assigning a received first order to an agent while a threshold time limit for a user to select one or more items for bundling with the first order has not yet expired. In some examples, the delay may be associated with the threshold time limit so as to expire after the threshold time limit has expired. This operation may correspond to block 1016 of FIG. 10 discussed above.

At 1104, the service computing device may receive, via an API, from the user application executing on the user device, an indication of user activity with the user application, such as to remotely determine whether the user is browsing the items available from one of the second merchants, whether the user is not browsing the items, whether the user has closed the user application, whether the user has left the application idle while using other applications, and so forth. For instance, the user application executing on the user device may monitor and communicate to the service computing device the user interactions with respect to the second merchant(s) and the second merchant's items, menus, etc. For example, the API may be configured to communicate user interactions with the application user interface to the service computing device.

At 1106, the service computing device may determine whether a selection of a second item from one of the selected second merchants has been received. If so, the process goes to 1122. If not, the process goes to 1108.

At 1108, the service computing device may determine whether the application on the user device has been closed for a predetermined time. For example, if the user accidentally closes the application and immediately reopens the application, then the delay may be maintained, as the user may still be interested in selecting an item from a second merchant for bundling. On the other hand, if the application has been closed for a predetermined time, e.g., 30 seconds, 1 minute, etc., then the process goes to 1122. If not, the process goes to 1110.

At 1110, the service computing device may determine whether the application on the user device has been idle for a predetermined amount of time. For example, if there has been no interaction of the user with the user interface of the application for a predetermined amount of time, such as 2 minutes, 3 minutes, etc., then the user is likely using a different application or is occupied elsewhere. If so, the process goes to 1122. If not, the process goes to 1112.

At 1112, the service computing device may determine whether the threshold time limit presented on the user device has expired. If so, the process goes to 1114. If not, the process goes back to 1106.

At 1114, the service computing device may determine whether browsing activity has been detected with the user interface of the application on the user device. If so, the process goes to 1116. If not, the process goes to 1122.

At 1116, if browsing activity is detected on the user device after the time limit has expired, the service computing device may send, to the user device, a message inquiring as to whether the user would like more time to browse second merchant items.

At 1118, the service computing device may determine whether a request for more time was received in response to the message. If so, the process goes to 1120. If not, the process goes to 1122.

At 1120, the service computing device may extend the delay for a period of time, such as 2 minutes, 3 minutes, etc., and the process returns to 1106.

At 1122, the service computing device may send, to the agent device, pickup and delivery information for the first order, and pickup and delivery information for any items from the second merchant(s) selected for bundling with the first order.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, the implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

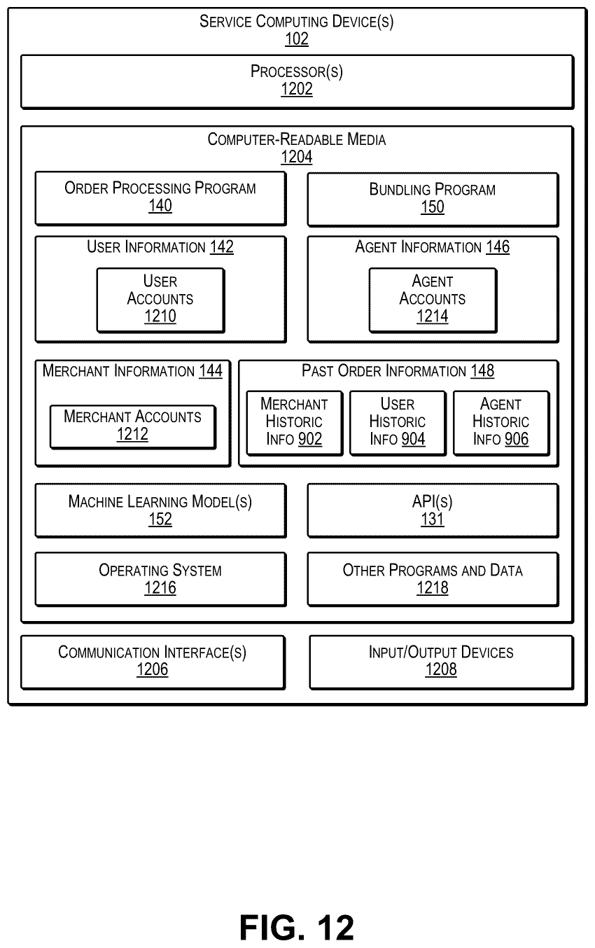

FIG. 12 illustrates select components of the service computing device(s) 102 that may be used to implement some functionality of the bundle order processing services described herein. The service computing device(s) 102 may include one or more servers or other types of computing devices that may be embodied in any number of ways. For instance, in the case of a server, the modules, other functional components, and data may be implemented on a single server, a cluster of servers, a server farm or data center, a cloud-hosted computing service, and so forth, although other computer architectures may additionally or alternatively be used.

Further, while the figures illustrate the components and data of the service computing device(s) 102 as being present in a single location, these components and data may alternatively be distributed across different computing devices and different locations in any manner. Consequently, the functions may be implemented by one or more service computing devices, with the various functionality described above distributed in various ways across the different computing devices. Multiple service computing devices 102 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, each service computing device(s) 102 may include one or more processors 1202, one or more computer-readable media 1204, one or more communication interfaces 1206, and input/output devices 1208. Each processor 1202 may be a single processing unit or a number of processing units, and may include single or multiple computing units or multiple processing cores. The processor(s) 1202 can be implemented as one or more microprocessors, microcomputers, microcontrollers, digital signal processors, central processing units, state machines, logic circuitries, and/or any devices that manipulate signals based on operational instructions. For instance, the processor(s) 1202 may be one or more hardware processors and/or logic circuits of any suitable type specifically programmed or configured to execute the algorithms and processes described herein. The processor(s) 1202 can be configured to fetch and execute computer-readable instructions stored in the computer-readable media 1204, which can program the processor(s) 1202 to perform the functions described herein.

The computer-readable media 1204 may include volatile and nonvolatile memory and/or removable and non-removable media implemented in any type of technology for storage of information, such as computer-readable instructions, data structures, program modules, or other data. Such computer-readable media 1204 may include, but is not limited to, RAM, ROM, EEPROM, flash memory or other memory technology, optical storage, solid state storage, magnetic tape, magnetic disk storage, storage arrays, network attached storage, storage area networks, cloud storage, or any other medium that can be used to store the desired information and that can be accessed by a computing device. Depending on the configuration of the service computing device(s) 102, the computer-readable media 1204 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 1204 may be used to store any number of functional components that are executable by the processors 1202. In many implementations, these functional components comprise instructions or programs that are executable by the processors 1202 and that, when executed, specifically configure the one or more processors 1202 to perform the actions attributed above to the service computing device(s) 102. Functional components stored in the computer-readable media 1204 may include the order processing program 140 and the bundling program 150. Additional functional components stored in the computer-readable media 1204 may include an operating system 1216 for controlling and managing various functions of the service computing device(s) 102.

In addition, the computer-readable media 1204 may store data used for performing the operations described herein. Thus, the computer-readable media 1204 may store the user information 142, including user accounts 1210, the merchant information 144, including merchant accounts 1212, and the agent information 146, including agent accounts 1214. Further, the computer-readable media 1204 may include the past order information 146, such as the merchant historic information 902, the user historic information 904, and the agent historic information 906. The service computing device(s) 102 may also include or maintain other functional components and data not specifically shown in FIG. 12, such as other programs and data 1218, which may include programs, drivers, etc., and the data used or generated by the functional components. Further, the service computing device(s) 102 may include many other logical, programmatic, and physical components, of which those described above are merely examples that are related to the discussion herein.

The communication interface(s) 1206 may include one or more interfaces and hardware components for enabling communication with various other devices, such as over the network(s) 106. For example, communication interface(s) 1206 may enable communication through one or more of the Internet, cable networks, cellular networks, wireless networks (e.g., Wi-Fi) and wired networks (e.g., fiber optic and Ethernet), as well as short-range communications, such as BLUETOOTH®, and the like, as additionally enumerated elsewhere herein.

The service computing device(s) 102 may further be equipped with various input/output (I/O) devices 1208. Such I/O devices 1208 may include a display, various user interface controls (e.g., buttons, joystick, keyboard, mouse, touch screen, etc.), audio speakers, connection ports and so forth.

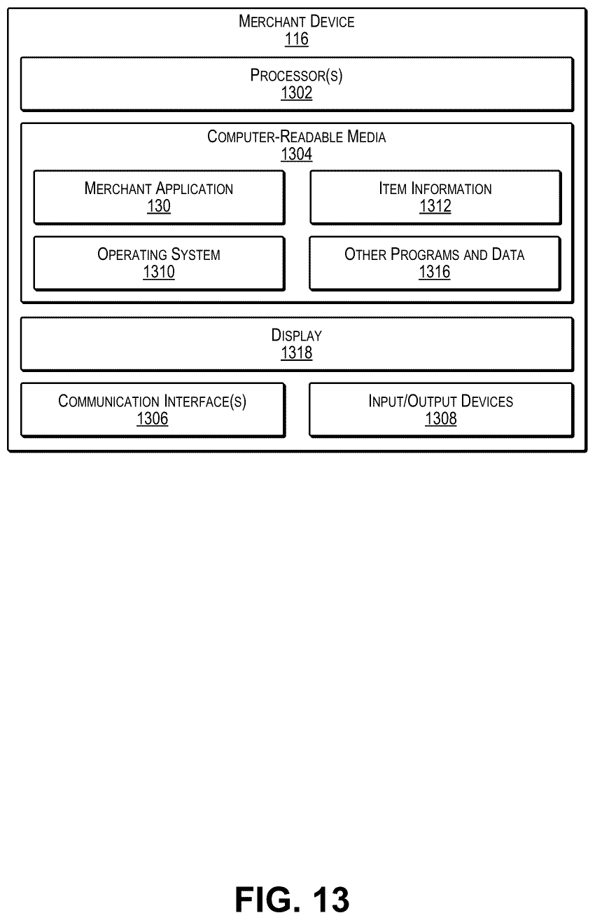

FIG. 13 illustrates select example components of an example merchant device 116 according to some implementations. The merchant device 116 may be any suitable type of computing device, e.g., portable, semi-portable, semi-stationary, or stationary. Some examples of the merchant device 116 may include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices, or other body-mounted computing devices; augmented reality devices; or other computing devices capable of sending communications and performing the functions according to the techniques described herein.

In the illustrated example, the merchant device 116 includes at least one processor 1302, one or more computer-readable media 1304, one or more communication interfaces 1306, and one or more input/output (I/O) devices 1308. Each processor 1302 may itself comprise one or more processors or processing cores. For example, the processor 1302 can be implemented as one or more microprocessors, microcomputers, microcontrollers, digital signal processors, central processing units, state machines, logic circuitries, and/or any devices that manipulate signals based on operational instructions. In some cases, the processor 1302 may be one or more hardware processors and/or logic circuits of any suitable type specifically programmed or configured to execute the algorithms and processes described herein. The processor 1302 can be configured to fetch and execute computer-readable processor-executable instructions stored in the computer-readable media 1304.

Depending on the configuration of the merchant device 116, the computer-readable media 1304 may be an example of tangible non-transitory computer storage media and may include volatile and nonvolatile memory and/or removable and non-removable media implemented in any type of technology for storage of information such as computer-readable processor-executable instructions, data structures, program modules, or other data. The computer-readable media 1304 may include, but is not limited to, RAM, ROM, EEPROM, flash memory, solid-state storage, magnetic disk storage, optical storage, and/or other computer-readable media technology. Further, in some cases, the merchant device 116 may access external storage, such as storage arrays, network attached storage, storage area networks, cloud storage, or any other medium that can be used to store information and that can be accessed by the processor 1302 directly or through another computing device or network. Accordingly, the computer-readable media 1304 may be computer storage media able to store instructions, modules, or components that may be executed by the processor 1302. Further, when mentioned, non-transitory computer-readable media exclude media such as energy, carrier signals, electromagnetic waves, and signals per se.

The computer-readable media 1304 may be used to store and maintain any number of functional components that are executable by the processor 1302. In some implementations, these functional components comprise instructions or programs that are executable by the processor 1302 and that, when executed, implement operational logic for performing the actions and services attributed above to the merchant device 116. Functional components of the merchant device 116 stored in the computer-readable media 1304 may include the merchant application 130. In some examples, the merchant application 130 may include transaction processing capability, such as for presenting an interface to enable the merchant to conduct transactions, receive payments, and so forth, as well as communicating with the service computing device(s) 102 for processing payments, sending transaction information, receiving order information, sending merchant information, and so forth. Additional functional components may include an operating system 1310 for controlling and managing various functions of the merchant device 116 and for enabling basic user interactions with the merchant device 116.

In addition, the computer-readable media 1304 may also store data, data structures and the like, that are used by the functional components. For example, data stored by the computer-readable media 1304 may include item information 1312 that includes information about the items offered by the merchant, which may include images of the items, descriptions of the items, prices of the items, preparation times for the items, and so forth. Depending on the type of the merchant device 116, the computer-readable media 1304 may also optionally include other functional components and data, such as other programs and data 1316, which may include programs, drivers, etc., and the data used or generated by the functional components. Further, the merchant device 116 may include many other logical, programmatic, and physical components, of which those described are merely examples that are related to the discussion herein.

The communication interface(s) 1306 may include one or more interfaces and hardware components for enabling communication with various other devices, such as over the network(s) 106 or directly. For example, communication interface(s) 1306 may enable communication through one or more of the Internet, cable networks, cellular networks, wireless networks (e.g., Wi-Fi) and wired networks, as well as short-range communications such as Bluetooth®, and the like, as additionally enumerated elsewhere herein.

FIG. 13 further illustrates that the merchant device 116 may include a display 1318. Depending on the type of computing device used as the merchant device 116, the display 1318 may employ any suitable display technology, and may have a touch sensor in some examples. Alternatively, in some examples, the merchant device 116 may not include the display 1318, and information may be presented by other means, such as by sound.

The merchant device 116 may further include the one or more I/O devices 1308. The I/O devices 1308 may include speakers, a microphone, a camera, and various user controls (e.g., buttons, a joystick, a keyboard, a keypad, etc.), a haptic output device, and so forth. Additionally, the merchant device 116 may include various other components that are not shown, examples of which include sensors, removable storage, a power source, such as a battery and power control unit, and so forth.

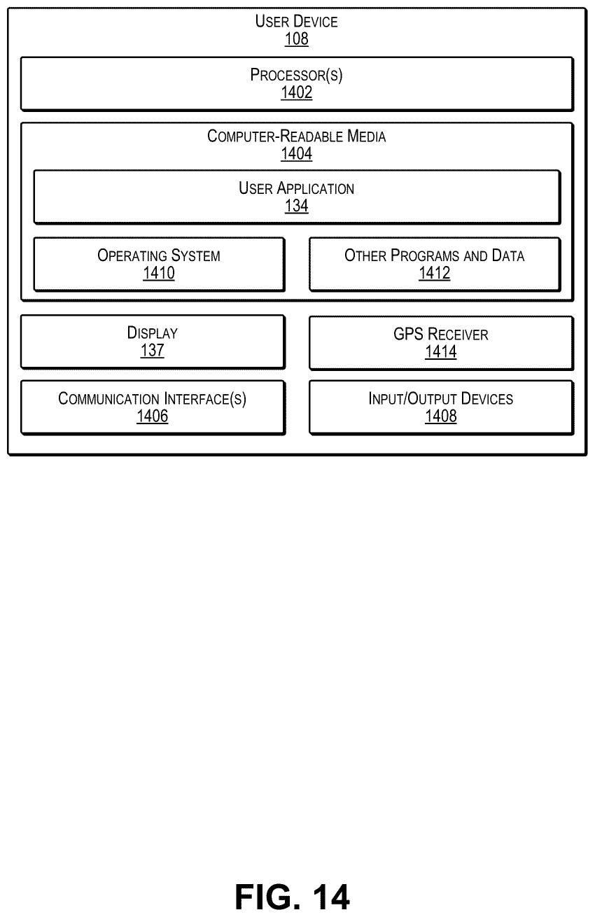

FIG. 14 illustrates select example components of the user device 108 that may implement the functionality described above according to some examples. The user device 108 may be any of a number of different types of computing devices. Some examples of the user device 108 may include smart phones and mobile communication devices; tablet computing devices; laptops, netbooks and other portable computers; wearable computing devices and/or body-mounted computing devices, which may include watches and augmented reality devices, such as helmets, goggles or glasses; and any other portable device capable of sending communications and performing the functions according to the techniques described herein. Further, in some examples, the user device 108 may be a stationary or semi-stationary computing device, such as a desktop computer or other device with computing capabilities.

In the example of FIG. 14, the user device 108 includes components such as at least one processor 1402, one or more computer-readable media 1404, one or more communication interfaces 1406, and one or more input/output (I/O) devices 1408. Each processor 1402 may itself comprise one or more processors or processing cores. For example, the processor 1402 can be implemented as one or more microprocessors, microcomputers, microcontrollers, digital signal processors, central processing units, state machines, logic circuitries, and/or any devices that manipulate signals based on operational instructions. In some cases, the processor 1402 may be one or more hardware processors and/or logic circuits of any suitable type specifically programmed or configured to execute the algorithms and processes described herein. The processor 1402 can be configured to fetch and execute computer-readable processor-executable instructions stored in the computer-readable media 1404.

Depending on the configuration of the user device 108, the computer-readable media 1404 may be an example of tangible non-transitory computer storage media and may include volatile and nonvolatile memory and/or removable and non-removable media implemented in any type of technology for storage of information such as computer-readable processor-executable instructions, data structures, program modules, or other data. The computer-readable media 1404 may include, but is not limited to, RAM, ROM, EEPROM, flash memory, solid-state storage, magnetic disk storage, optical storage, and/or other computer-readable media technology. Further, in some cases, the user device 108 may access external storage, such as storage arrays, network attached storage, storage area networks, cloud storage, or any other medium that can be used to store information and that can be accessed by the processor 1402 directly or through another computing device or network. Accordingly, the computer-readable media 1404 may be computer storage media able to store instructions, modules, or components that may be executed by the processor 1402. Further, when mentioned, non-transitory computer-readable media exclude media such as energy, carrier signals, electromagnetic waves, and signals per se.

The computer-readable media 1404 may be used to store and maintain any number of functional components that are executable by the processor 1402. In some implementations, these functional components comprise instructions or programs that are executable by the processor 1402 and that, when executed, implement operational logic for performing the actions and services attributed above to the user device 108. Functional components of the user device 108 stored in the computer-readable media 1404 may include the user application 134, as discussed above, which may present the user with one or more user interfaces for placing orders for items, some examples of which are described above. Additional functional components may include an operating system 1410 for controlling and managing various functions of the user device 108 and for enabling basic user interactions with the user device 108.

In addition, the computer-readable media 1404 may also store data, data structures and the like, that are used by the functional components. Depending on the type of the user device 108, the computer-readable media 1404 may also optionally include other functional components and data, such as other programs and data 1412, which may include applications, programs, drivers, etc., and the data used or generated by the functional components. Further, the user device 108 may include many other logical, programmatic, and physical components, of which those described are merely examples that are related to the discussion herein.

The communication interface(s) 1406 may include one or more interfaces and hardware components for enabling communication with various other devices, such as over the network(s) 106 or directly. For example, communication interface(s) 1406 may enable communication through one or more of the Internet, cable networks, cellular networks, wireless networks (e.g., Wi-Fi) and wired networks (e.g., fiber optic, Ethernet), as well as short-range communications such as BLUETOOTH®, and the like, as additionally enumerated elsewhere herein.

FIG. 14 further illustrates that the user device 108 may include the display 137, which may employ any suitable display technology. In some examples, the display 137 may have a touch sensor to provide a touchscreen display. The user device 108 may further include the one or more I/O devices 1408. The I/O devices 1408 may include speakers, a microphone, a camera, and various user controls (e.g., buttons, a joystick, a keyboard, a keypad, etc.), a haptic output device, and so forth. Other components included in the user device 108 may include various types of sensors, which may include a GPS receiver 1414 able to indicate location information, as well as other sensors (not shown) such as an accelerometer, gyroscope, compass, proximity sensor, and the like. In some cases, the GPS receiver 1414 may be used by the user application 134 to determine or confirm a current geographic location of the user device 108. Additionally, or alternatively, the communication interfaces 1406 may be used to determine the current location of the user device 108, such as based on communication with nearby cell towers, wireless access points, and the like. In some examples, the user application 134 may send this location information to the service computing device as an indicated delivery location for the associated user. Additionally, the user device 108 may include various other components that are not shown, examples of which include removable storage, a power source, such as a battery and power control unit, and so forth.

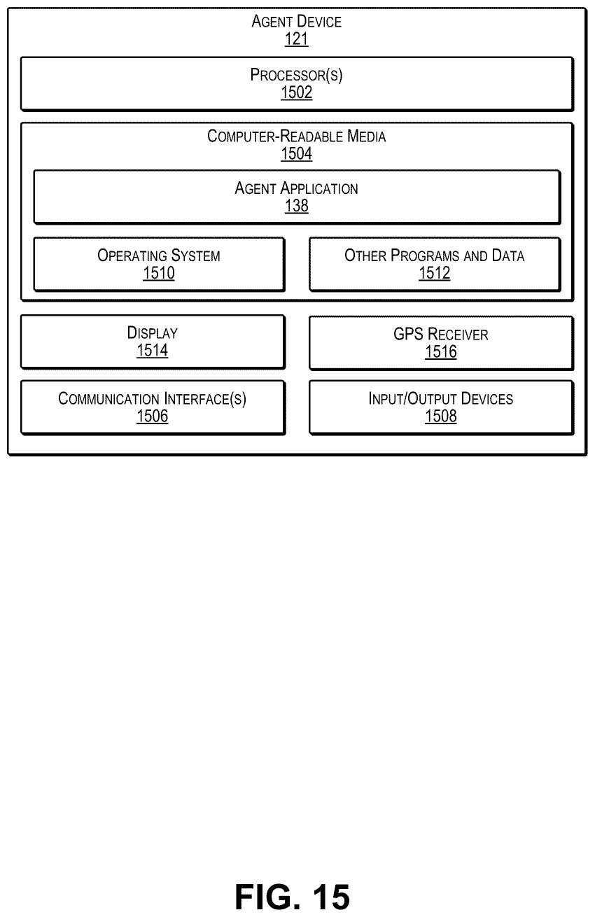

FIG. 15 illustrates select example components of the agent device 121 that may implement the functionality described above according to some examples. The agent device 121 may be any of a number of different types of portable computing devices. Some examples of the agent device 121 may include smart phones and mobile communication devices; tablet computing devices; laptops, netbooks and other portable computers; wearable computing devices and/or body-mounted computing devices, which may include watches and augmented reality devices, such as helmets, goggles or glasses; and any other portable device capable of sending communications and performing the functions according to the techniques described herein.

In the example of FIG. 15, the agent device 121 includes components such as at least one processor 1502, one or more computer-readable media 1504, one or more communication interfaces 1506, and one or more input/output (I/O) devices 1508. Each processor 1502 may itself comprise one or more processors or processing cores. For example, the processor 1502 can be implemented as one or more microprocessors, microcomputers, microcontrollers, digital signal processors, central processing units, state machines, logic circuitries, and/or any devices that manipulate signals based on operational instructions. In some cases, the processor 1502 may be one or more hardware processors and/or logic circuits of any suitable type specifically programmed or configured to execute the algorithms and processes described herein. The processor 1502 can be configured to fetch and execute computer-readable processor-executable instructions stored in the computer-readable media 1504.

Depending on the configuration of the agent device 121, the computer-readable media 1504 may be an example of tangible non-transitory computer storage media and may include volatile and nonvolatile memory and/or removable and non-removable media implemented in any type of technology for storage of information such as computer-readable processor-executable instructions, data structures, program modules, or other data. The computer-readable media 1504 may include, but is not limited to, RAM, ROM, EEPROM, flash memory, solid-state storage, magnetic disk storage, optical storage, and/or other computer-readable media technology. Further, in some cases, the agent device 121 may access external storage, such as storage arrays, network attached storage, storage area networks, cloud storage, or any other medium that can be used to store information and that can be accessed by the processor 1502 directly or through another computing device or network. Accordingly, the computer-readable media 1504 may be computer storage media able to store instructions, modules, or components that may be executed by the processor 1502. Further, when mentioned, non-transitory computer-readable media exclude media such as energy, carrier signals, electromagnetic waves, and signals per se.

The computer-readable media 1504 may be used to store and maintain any number of functional components that are executable by the processor 1502. In some implementations, these functional components comprise instructions or programs that are executable by the processor 1502 and that, when executed, implement operational logic for performing the actions and services attributed above to the agent device 121. Functional components of the agent device 121 stored in the computer-readable media 1504 may include the agent application 138, as discussed above. Additional functional components may include an operating system 1510 for controlling and managing various functions of the agent device 121 and for enabling basic user interactions with the agent device 121.

In addition, the computer-readable media 1504 may also store data, data structures and the like, that are used by the functional components. Depending on the type of the agent device 121, the computer-readable media 1504 may also optionally include other functional components and data, such as other programs and data 1512, which may include applications, programs, drivers, etc., and the data used or generated by the functional components. Further, the agent device 121 may include many other logical, programmatic, and physical components, of which those described are merely examples that are related to the discussion herein.

The communication interface(s) 1506 may include one or more interfaces and hardware components for enabling communication with various other devices, such as over the network(s) 106 or directly. For example, communication interface(s) 1506 may enable communication through one or more of the Internet, cable networks, cellular networks, wireless networks (e.g., Wi-Fi) and wired networks (e.g., fiber optic, Ethernet), as well as close-range communications such as BLUETOOTH®, and the like, as additionally enumerated elsewhere herein.

FIG. 15 further illustrates that the agent device 121 may include a display 1014, which may be any of various types of displays. The agent device 121 may further include the one or more I/O devices 1508. The I/O devices 1508 may include speakers, a microphone, a camera, and various user controls (e.g., buttons, a joystick, a keyboard, a keypad, etc.), a haptic output device, and so forth. Other components included in the agent device 121 may include various types of sensors, which may include a GPS receiver 1516 able to indicate location information, as well as other sensors (not shown) such as an accelerometer, gyroscope, compass, proximity sensor, and the like. In some cases, the GPS receiver 1516 may be used by the agent application 138 to determine a current geographic location of the agent device 121. Additionally, or alternatively, the communication interfaces 1506 may be used to determine the current location of the agent device, such as based on communication with nearby cell towers, wireless access points, and the like. In some examples, the agent application 138 may send this location information periodically to the service computing device as an indicated location of the associated agent. Additionally, the agent device 121 may include various other components that are not shown, examples of which include removable storage, a power source, such as a battery and power control unit, and so forth.

Various instructions, processes, and techniques described herein may be considered in the general context of computer-executable instructions, such as computer programs and applications stored on computer-readable media, and executed by the processor(s) herein. Generally, the terms program and application may be used interchangeably, and may include instructions, routines, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed:

1. A method comprising:
receiving, by a computing device, from an application executing on a mobile device associated with a user, a first communication requiring the computing device to perform at least a first action, wherein the application presents a user interface on the mobile device that enables the user to interact with the application;
in response to receiving the first communication, implementing, by the computing device, a first time period during which the computing device waits before performing the first action;
receiving, by the computing device, in real time and via an application programming interface (API), one or more second communications indicative of user activity with respect to the application, the one or more second communications indicating one of:
the user is actively interacting with the user interface on the mobile device; or
the application has been closed on the mobile device for a threshold time;
based at least on receiving, in real time and via the API, the one or more second communications, one of:
based on receiving an indication that the application has been closed on the mobile device for the threshold time, performing, by the computing device, the first action before expiration of the first time period; or
based on receiving an indication that the user is actively interacting with the user interface on the mobile device, performing, by the computing device, after the expiration of the first time period, at least one of the first action or a second action.

2. The method as recited in claim 1, wherein the first action includes sending a communication to another mobile device.

3. The method as recited in claim 1, wherein the second action includes sending a communication to the mobile device associated with the user for determining whether to implement a second time period before performing the first action.

4. The method as recited in claim 3, wherein, following implementation of the second time period after the expiration of the first time period, the second communications continue to be received via the API in real time.

5. The method as recited in claim 1, further comprising:
based at least on receiving, from the mobile device, a third communication indicating a user input via the user interface, performing at least the first action immediately and prior to termination of the first time period.

6. The method as recited in claim 1, wherein an indication that the user is actively interacting with the user interface on the mobile device includes detecting, by the API, browsing activity in the user interface.

7. The method as recited in claim 1, further comprising:
following receipt of the first communication, sending, by the computing device, a communication to the mobile device to cause the user interface to present information related to the first time period.

8. A system comprising one or more processors configured by executable instructions to perform operations comprising:
receiving, by the one or more processors, from an application executing on a mobile device associated with a user, a first communication requiring the one or more processors to perform at least a first action, wherein the application presents a user interface on the mobile device that enables the user to interact with the application;
in response to receiving the first communication, implementing, by the one or more processors, a first time period during which the one or more processors wait before performing the first action;
receiving, by the one or more processors, in real time and via an application programming interface (API), one or more second communications indicative of user activity with respect to the application, the one or more second communications indicating one of:
the user is actively interacting with the user interface on the mobile device; or
the application has been closed on the mobile device for a threshold time;
based at least on receiving, in real time and via the API, the one or more second communications, one of:
based on receiving an indication that the application has been closed on the mobile device for the threshold time, performing, by the one or more processors, the first action before expiration of the first time period; or
based on receiving an indication that the user is actively interacting with the user interface on the mobile device, performing, by the one or more processors, after the expiration of the first time period, at least one of the first action or a second action.

9. The system as recited in claim 8, wherein the first action includes sending a communication to another mobile device.

10. The system as recited in claim 8, wherein the second action includes sending a communication to the mobile device associated with the user for determining whether to implement a second time period before performing the first action.

11. The system as recited in claim 10, wherein, following implementation of the second time period after the expiration of the first time period, the second communications continue to be received via the API in real time.

12. The system as recited in claim 8, the operations further comprising:
based at least on receiving, from the mobile device, a third communication indicating a user input via the user interface, performing at least the first action immediately and prior to termination of the first time period.

13. The system as recited in claim 8, wherein an indication that the user is actively interacting with the user interface on the mobile device includes detecting, by the API, browsing activity in the user interface.

14. The system as recited in claim 8, the operations further comprising:
following receipt of the first communication, sending, by the one or more processors, a communication to the mobile device to cause the user interface to present information related to the first time period.

15. One or more non-transitory computer-readable media storing instructions that, when executed by one or more processors, configure the one or more processors to perform operations comprising:
receiving, by the one or more processors, from an application executing on a mobile device associated with a user, a first communication requiring the one or more processors to perform at least a first action, wherein the application presents a user interface on the mobile device that enables the user to interact with the application;
in response to receiving the first communication, implementing, by the one or more processors, a first time period during which the one or more processors wait before performing the first action;
receiving, by the one or more processors, in real time and via an application programming interface (API), one or more second communications indicative of user activity with respect to the application, the one or more second communications indicating one of:
the user is actively interacting with the user interface on the mobile device; or
the application has been closed on the mobile device for a threshold time;
based at least on receiving, in real time and via the API, the one or more second communications, one of:
based on receiving an indication that the application has been closed on the mobile device for the threshold time, performing, by the one or more processors, the first action before expiration of the first time period; or
based on receiving an indication that the user is actively interacting with the user interface on the mobile device, performing, by the one or more processors, after the expiration of the first time period, at least one of the first action or a second action.

16. The one or more non-transitory computer-readable media as recited in claim 15, wherein the first action includes sending a communication to another mobile device.

17. The one or more non-transitory computer-readable media as recited in claim 15, wherein the second action includes sending a communication to the mobile device associated with the user for determining whether to implement a second time period before performing the first action.

18. The one or more non-transitory computer-readable media as recited in claim 15, the operations further comprising:
based at least on receiving, from the mobile device, a third communication indicating a user input via the user interface, performing at least the first action immediately and prior to termination of the first time period.

19. The one or more non-transitory computer-readable media as recited in claim 15, wherein an indication that the user is actively interacting with the user interface on the mobile device includes detecting, by the API, browsing activity in the user interface.

20. The one or more non-transitory computer-readable media as recited in claim 15, the operations further comprising:
following receipt of the first communication, sending, by the one or more processors, a communication to the mobile device to cause the user interface to present information related to the first time period.
